(19) United States
(12) Patent Application Publication
(10) Pub. No.: US 2024/0326989 A1
(43) Pub. Date: Oct. 3, 2024

(54) SYSTEMS AND METHODS FOR AIRCRAFT WING SURFACES WITH AERODYNAMIC PATTERNS

(71) Applicant: New Mexico Tech University Research Park Corporation, Socorro, NM (US)

(72) Inventors: Brenden Herkenhoff, Rio Rancho, NM (US); Mostafa Hassanalian, Albuquerque, NM (US); Ahmed Aboelezz, Socorro, NM (US)

(21) Appl. No.: 18/442,940

(22) Filed: Feb. 15, 2024

Related U.S. Application Data
(60) Provisional application No. 63/445,965, filed on Feb. 15, 2023.

(51) Int. Cl. B64C 21/10; B64C 3/00

(52) U.S. Cl. CPC B64C 21/10; B64C 3/00

(57) ABSTRACT

Systems and methods for aircraft wing surfaces with aerodynamic patterns are disclosed. A wing of an aircraft includes an outer surface and a color pattern on the outer surface. The color pattern includes a dark color region and a light color region. The dark color region is formed of a dark color having a dark absorptivity value. The light color region is formed of a light color having a light absorptivity value. The dark absorptivity value is greater than the light absorptivity value. The dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

### CROSS-REFERENCE TO RELATED APPLICATION

This application claims the benefit of U.S. Provisional Patent Application Ser. No. 63/445,965, filed on Feb. 15, 2023, which is incorporated by reference herein in its entirety.

### STATEMENT REGARDING FEDERALLY SPONSORED RESEARCH OR DEVELOPMENT

Not applicable.

### TECHNICAL FIELD

Embodiments of the present disclosure generally relates to aircraft wing surfaces and, more specifically, to systems and methods for aircraft wing surfaces with aerodynamic patterns.

### BACKGROUND

With the reduction in fossil fuel usage and increased focus on energy efficiency in recent decades, the research and design of novel systems to reduce power consumption and harvest energy from available renewable sources have become paramount. One particular field of interest resides in the sky. According to the Environmental Protection Agency, in 2018, 28% of greenhouse gas emissions were produced through the transportation industry, and over 2.5% of the global CO2 emissions came from the aviation industry. The altitude at which these gasses are emitted is of significant concern as it has a greater impact on the atmosphere. Aircraft typically cruise at altitudes where the troposphere meets the stratosphere. Emissions at these altitudes have a different and often more lasting impact on atmospheric chemistry compared to emissions at ground level. For instance, nitrogen oxides (NOx) emitted from aircraft can have a greater ozone-depleting effect when released in the stratosphere. At these altitudes, the emitted pollutants disperse more slowly due to the thinness of the atmosphere and prevailing meteorological conditions. This can lead to a more concentrated impact on atmospheric chemistry in these regions. These altitude-specific phenomena underscore the necessity for innovative approaches in aviation to mitigate their unique contributions to atmospheric change.

In light of these statistics, the research and development of energy harvesting and energy usage reduction technologies for the aviation industry has become a highly sought-after topic and one with a plethora of opportunities. Conceptual inspiration for embodiments of the present invention comes from avian flights and their physical characteristics. Bioinspiration and biomimicry are some of the greatest potential sources of engineering inspiration as nature has the advantage of time. To improve the efficiency of survival systems, including for example energy usage reduction during flight, a myriad of techniques have been developed. Some of the most prominent take advantage of phenomena in nature, including for example wind shears, via dynamic soaring or aerodynamic phenomena including for example ground effect. However, there remains an urgent and ongoing need for innovative methods that enhance flight efficiency and performance, transcending traditional mechanical modifications.

### SUMMARY

The appended claims define this application. The present document discloses aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for systems and methods for aircraft wing surfaces with aerodynamic patterns. An example wing of an aircraft includes an outer surface and a color pattern on the outer surface. The color pattern includes a dark color region and a light color region. The dark color region is formed of a dark color having a dark absorptivity value. The light color region is formed of a light color having a light absorptivity value. The dark absorptivity value is greater than the light absorptivity value. The dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

Another example wing of an aircraft includes an outer surface and one or more active heating elements arranged to form a heat flux region along the outer surface. The heat flux region is configured to manipulate a heat flux of the outer surface of the wing that affects at least one of a pressure gradient or a velocity gradient surrounding the wing to affect at least one of a vortex generation, a lift, a drag, or a lift-to-drag ratio of the wing.

An example method of forming a wing of an aircraft includes applying a color pattern having a dark color region and a light color region to an outer surface of the wing by applying a dark color having a dark absorptivity value to a dark color region and applying a light color having a light absorptivity value to the light color region. The dark absorptivity value is greater than the light absorptivity value. The dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention.

FIGS. 1A-1C are photographs birds which are respectively exhibiting, dynamic soaring, thermal soaring, and in ground effect energy harvesting.

FIGS. 2A-2X are pairs of photographs of black and white bird species: (2A) alpine chough, (2B) whooper swan, (2C) avocets, (2D) yellow-billed magpie, (2E) pied crow, (2F) magpie-lark, (2G) black-and-white-casqued hornbill, (2H) black-headed ibis, (2I) albatross, (2J) manx shearwater, (2K) black skimmer, (2L) white stork, (2M) swallow-tailed kite, (2N) bearded vulture, (2O) bar-headed goose, (2P) common crane, (2Q) Andean condor, (2R) rüppell's vulture, (2S) snow goose, (2T) whooping crane, (2U) Indian paradise flycatcher, (2V) white-browed wagtail, (2W) hoopoe, and (2X) black and white warbler.

FIG. 3 is a series of drawings which illustrate black and white coloration patters of bird wings as found in nature.

FIG. 4A is a drawing which illustrates a simulated sun irradiation setup configured to experimentally test wing coloration results.

FIGS. 4B, 4C, and 4D are respectively photographs of a black wing and a white wing (4B), a brown and blue and brown wing (4C), and a gray and white wing (4D) as used under the test setup illustrated in FIG. 4A.

FIG. 5 is a graph of radiation versus time for a heat lamp with 40 centimeter (“cm”) distance from a plate.

FIG. 6 is a series of infrared images that respectively illustrate the heat signatures of different wing colorations at three different times after being exposed to a heat lamp for time=0 (see “a” for each wing color), time=6 minutes (see “b” for each wing color), and time=12 minutes (see “c” for each wing color).

FIGS. 7A, 7B, 7C, 7D, 7E, 7F, and 7G are graphs which respectively illustrate (7A) surface temperature for a black wing, (7B) surface temperature for a white wing, (7C) comparison of surface temperatures for black and white wings, (7D) surface temperature for a brown and blue wing, (7E) surface temperature for a brown wing, (7F) surface temperature for a gray and white wing, (7G) comparison of average maximum temperature measurements for each wing.

FIG. 8 is a drawing which illustrates a 2-dimension (“2D”) view of a national advisory committee for aeronautics (“NACA”) 4415 airfoil with nickel chrome heating wires spaced out across its surface.

FIG. 9 is a series of photographs of an experimental heated wing constructed with heating wires.

FIG. 10 is a pair of photographs which illustrates an experimental wing having a silicone wing surface.

FIG. 11 is a pair of drawings which illustrate the heated wing of FIG. 9 in an experimental test setup in a wind tunnel.

FIG. 12 is a diagram which illustrates an experimental heated wire test wing.

FIGS. 13A, 13B, and 13C are photographs that respectively illustrate natural bird coloration patters for a Zebra pattern (13A), a black trailing edge (13B), and a black top (13C).

FIGS. 14A, 14B, 14C, 14D, and 14E are graphs which respectively illustrate views of lift, drag, and lift to drag versus angle of attack for non-heated and heated (45 degrees centigrade (“° C.”) and 61° C.) scenarios for (14A) leading-edge upper, (14B) middle front upper, (14C) trailing edge upper, (14D) middle middle-upper, and (14E) middle back upper.

FIGS. 15A, 15B, 15C, 15D, and 15E are graphs which respectively illustrate views of lift, drag, and lift to drag versus angle of attack for non-heated and heated (45° C. and 61° C.) scenarios for (15A) leading-edge lower, (15B) middle front lower, (15C) middle middle-lower, (15D) middle back lower, and (15E) trailing-edge lower.

FIGS. 16A, 16B, and 16C are graphs which respectively illustrate views of lift, drag, and lift to drag versus angle of attack for non-heated and heated (45° C. and 61° C.) scenarios for (16A) Zebra pattern bioinspired from Hoopoe, (16B) all upper heated region, and (16C) trailing-edge upper and middle back upper.

FIG. 17 is a series of graphs which illustrate the change in lift coefficient for each heating case versus the unheated measurement.

FIG. 18 is a series of graphs which illustrate the change in drag coefficient for each heating case versus the unheated measurement.

FIG. 19 is a series of graphs which illustrate the change in the lift to drag coefficient for each heating case versus the unheated measurement.

FIG. 20 is a series of graphs which illustrate the change in the lift coefficient at fixed angles of attack against the various heating locations along a wing (both cases of upper and lower surface heating are shown).

FIG. 21 is a series of graphs which illustrate the change in drag coefficient at fixed angles of attack against the various heating locations along the wind (both cases with upper surface and lower surface heating are shown).

FIG. 22 is a series of graphs which illustrate the change in lift to drag ratio at fixed angles of attack against the various heating locations along the wind (both cases with upper surface and lower surface heating are shown).

FIGS. 23A and 23B are drawings which respectively illustrate a computational fluid dynamics (“CFD”) mesh used for computer analysis and a closer view of the CFD mesh around the airfoil.

FIG. 23C is a table (“Table 3”) containing numerous examples of low angle of attack CFD results at 0 degrees.

FIG. 23D is a table (“Table 4”) containing numerous examples of medium angle of attack CFD results at 5 degrees.

FIG. 23E is a table (“Table 5”) containing numerous examples of high angle of attack CFD results at 10 degrees.

FIG. 23F is a table (“Table 6”) containing numerous graphs of tabulated pressure coefficient results for the low angle of attack examples of FIG. 23C.

FIG. 23G is a table (“Table 7”) containing numerous graphs of tabulated pressure coefficient results for the medium angle of attack examples of FIG. 23D.

FIG. 23H is a table (“Table 8”) containing numerous graphs of tabulated pressure coefficient results for the high angle of attack examples of FIG. 23E.

FIG. 24 is a view of an example pressure plot at 0 AOA with 1000 W/m\hat{ }2 heat flux for the high speed CFD simulations.

FIG. 25 is a view of an example velocity plot at 0 AOA with 1000 W/m\hat{ }2 heat flux for the high speed CFD simulations.

FIG. 26 is a view of an example temperature plot at 0 AOA with 1000 W/m\hat{ }2 heat flux for the high speed CFD simulations.

FIG. 27 is a drawing which illustrates an example of an embodiment with a dark color on a wingtip.

FIG. 28 is a drawing which illustrates an example of an embodiment with a dark color on a trailing edge of a wing.

FIG. 29 is a drawing which illustrates an example of an embodiment with a linear shape of a dark color on a trailing edge and a wingtip of a wing.

FIG. 30 is a drawing which illustrates an example of an embodiment with an exponential curved shape of a dark color on a trailing edge and a wingtip of a wing.

FIG. 31 is a drawing which illustrates an example of an embodiment with a pattern of alternating dark color and light color on a trailing edge of a wing.

FIG. 32 is a drawing which illustrates an example of an embodiment with a pattern of cord-wise dark color stripes on a wing.

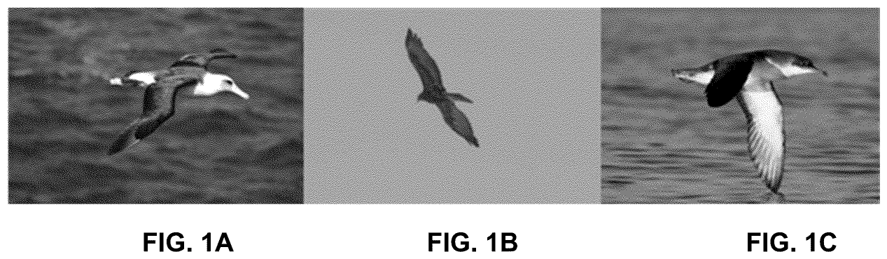

### DETAILED DESCRIPTION

Example systems and methods disclosed herein enhance flight efficiency and performance. This approach, uniquely grounded in the application of varied colors and/or patterns on aircraft wing surfaces, offers a groundbreaking solution. Disclosed methods and systems are not only remarkably elegant in their implementation, but are also versatile by catering to a wide spectrum of aircraft ranging from legacy fleets to the latest models. By integrating this technique, both existing and future aircraft can achieve substantial gains in aerodynamic efficiency and overall performance, marking a significant step forward in sustainable aviation practices.

It is often observed that many species of bird have dark and light wing colorations in various patterns. Specifically, birds that migrate over oceanic bodies of water have strong color patterns (for example a full black wing upper surface) exhibiting this trait. The albatross and shearwater, belonging to the Procellariform order, are two such oceanic birds that employ this trait. These specific birds are of interest due to their intensely long migratory paths and their ability to complete them with minimal energy expenditure. Their migratory routes mostly traverse the ocean, limiting the available sources of food and resting locations. Because of this, these birds have developed several different techniques to conserve and harvest energy from their environment, including wings coloration.

There are many theories behind the colors of a bird's feathers. Many of these theories point to the color's purpose to attract mates and hide from predators. Some recent investigations concluded that the dark colors of birds help in reducing the drag force during flight. It has been theorized that a bird's dark color not only reduces the drag but the color pattern improves the overall flight performance, and each color pattern has a different type of flight performance impact. In turn, this difference in improvement would be a result of variation in hot and cold surfaces on the bird skin as a result of the variation between light and dark feather colors.

Exampled systems and methods are disclosed herein for testing these theories and for identifying aerodynamic patterns for aircraft wing surfaces. Thermal images of real bird wings are captured under the effect of infrared waves. A novel wind tunnel wing, which has the ability to adjust the temperature in desired locations and patterns on the wing's surface, is manufactured, tested, and used to evaluate the effect of aerodynamics forces as a function of the surface temperature and the hot-cold regions. As disclosed below in greater detail, tests conducted with the test wing show potential flight efficiency improvements of 20%, comparing the lift to drag ratio for specific heating cases, which can increase the flight range. When individually considering lift and drag, the examples disclosed herein show specific heating cases with corresponding angles of attack in which these parameters improved by up to 20% and 7%, respectively. In some examples, the heating cases can increase the lift at a low angle of attack, which is helpful in cruise flight performance, while some cases can increase the maximum lift coefficient by 6%. This is very helpful in lowering stall and the minimum flight speeds. Furthermore, some cases can increase the lift-to-drag ratio, which leads to an increase in the flight range. Further, example methods and systems disclosed herein include conducting Computational Fluid Dynamics (“CFD”) simulations on the test wing geometry to better understand the effect of the various patterns to prove and verify the new theory through successful results from the wind tunnel experiments.

Example systems and methods disclosed herein include wing patterns with a coloration pattern that affects the heat flux of a surface and, thus, influences surface temperatures of the wing, which influences the pressure and velocity gradients surrounding the wing (the driving forces behind wing lifting). This characteristic influences the generated lift and drag of a wing as temperature rises and can be used to manipulate flight efficiency.

As used herein, the term “wing” refers to include any shape that provides aerodynamic and/or hydrodynamic lift, including but not limited to fixed wings, rotary wings, airfoils, elevators, flaps, other control surfaces, combinations thereof and the like. As used herein, the terms “angle of attack” and “AOA” refer to an angle at which a chord of a wing meets relative wind. As used herein, the term “high angle of attack” and “high AOA” refer to an angle of attack that is greater than about eight degrees. As used herein, the terms “low angle of attack” and “low AOA” refers to an angle of attack that is less than about four degrees. As used herein, the terms “mid angle of attack” and “mid-AOA” refers to an angle of attack that is between a high AOA and a low AOA.

Embodiments disclosed herein provide the ability to manipulate flight efficiency, most notably improved flight efficiency, based on wing color pattern. These color patterns can include color patterns which are and which are not typically observed in nature. All the scenarios examined in developing embodiments disclosed herein used a value of 95,024 for the Reynolds number and two temperatures (45° C. and 61° C.), while the room temperature was about 34° C. These two temperatures were used as the temperature differences of brown and black wings compared to the white wing, which are about 10° C. and 25° C., respectively, as will be shown later in the temperature variation experiment. The selection of the Reynolds number was made based on the bird's average flying Reynolds number, which is around 105. These values were selected as a basis for proving the hypothesis and by no means restrict the flow conditions under which embodiments disclosed herein may be used. It is anticipated that the induced efficiency improvements will be dependent on the flow conditions as higher velocities will lead to increased heat transfer rates.

To initialize this work, the temperature variation between black, brown, blue, and white wings under a controlled heat lamp were measured. This provided a base temperature difference between the two colors to be implemented in further experiments. Following this, a computer simulation was created to model a two-dimensional airfoil with a coupled fluid-thermal system analysis designed to observe the flow effects, as well as lift and drag around the airfoil as various heating patterns are applied. These results were then compared to experimental results using a small wing in a wind tunnel using the same heated regions. This allowed for the validation of the CFD analysis performed using computer software.

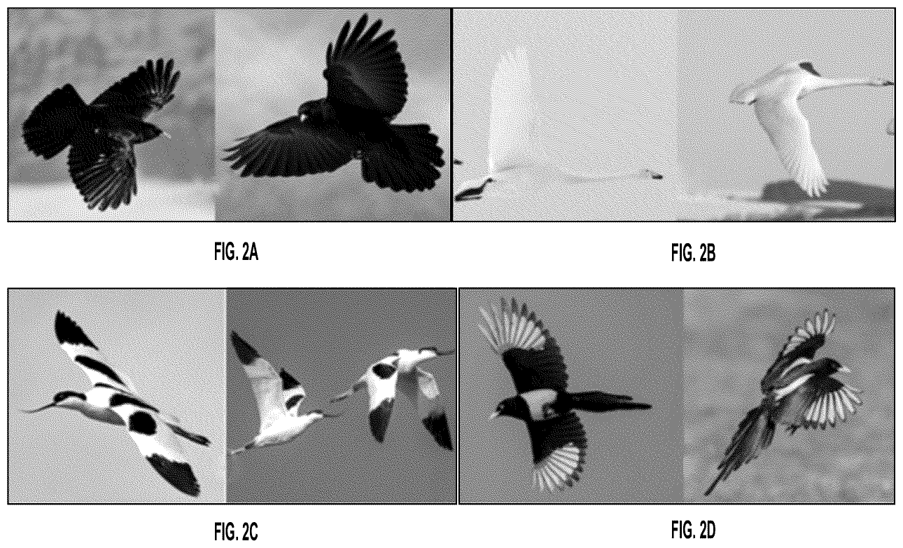

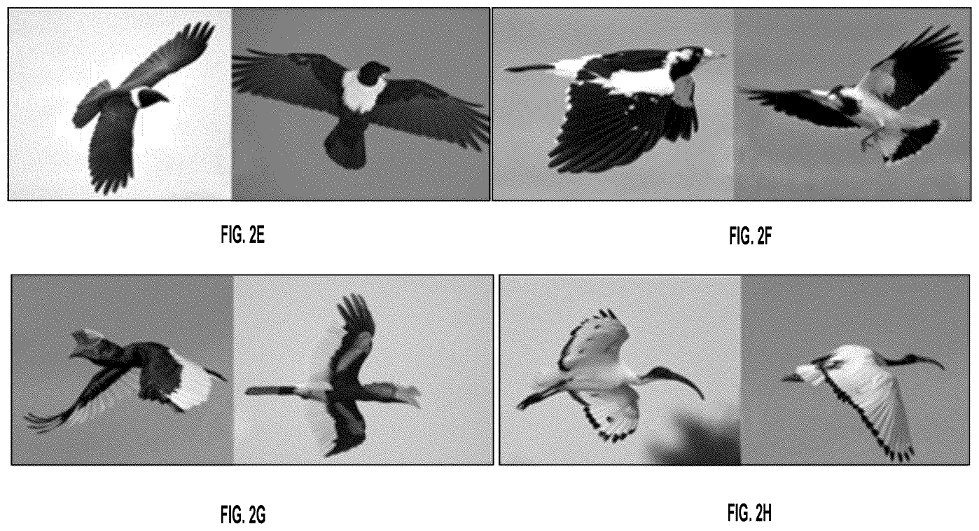

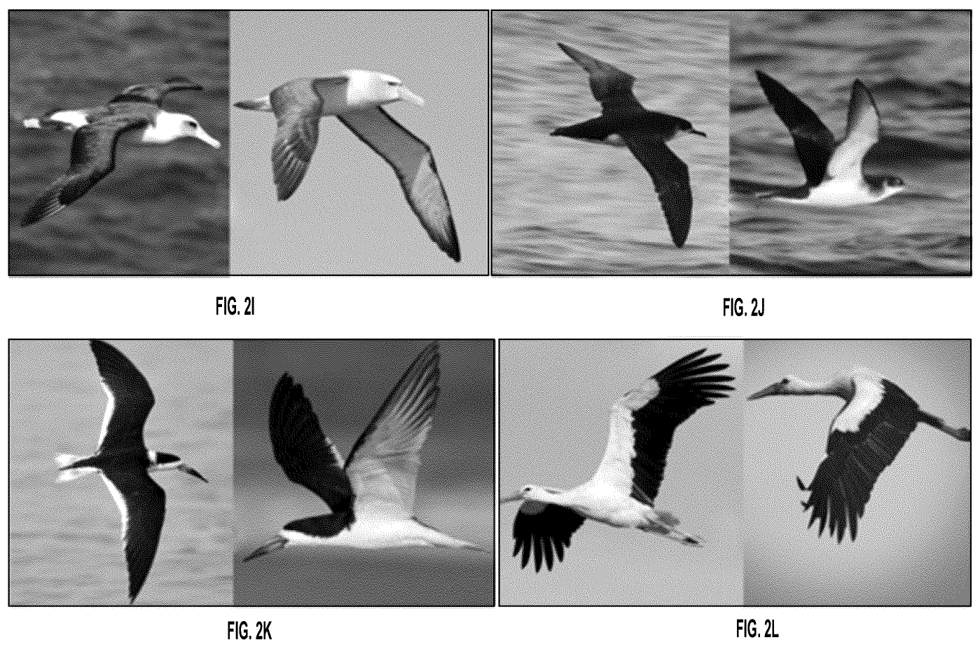

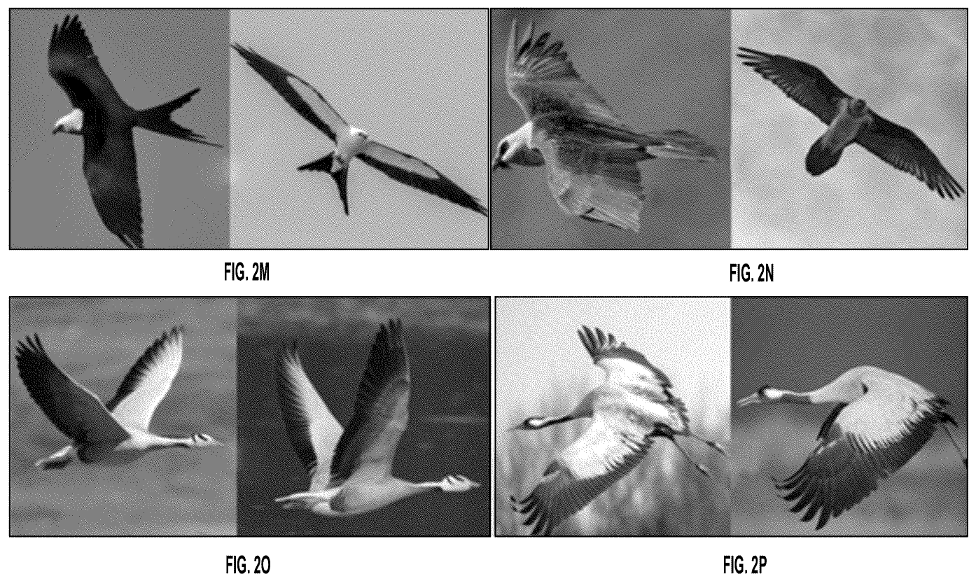

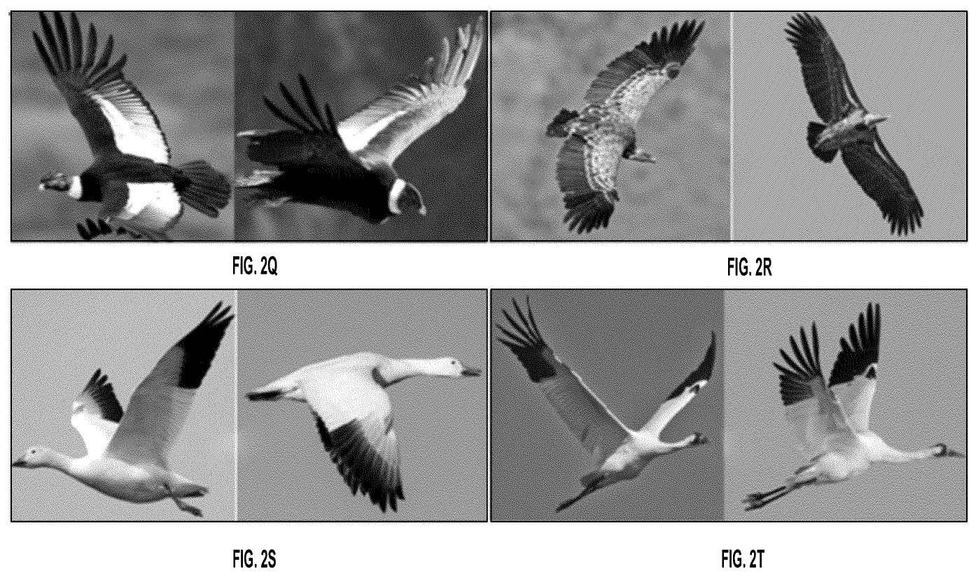

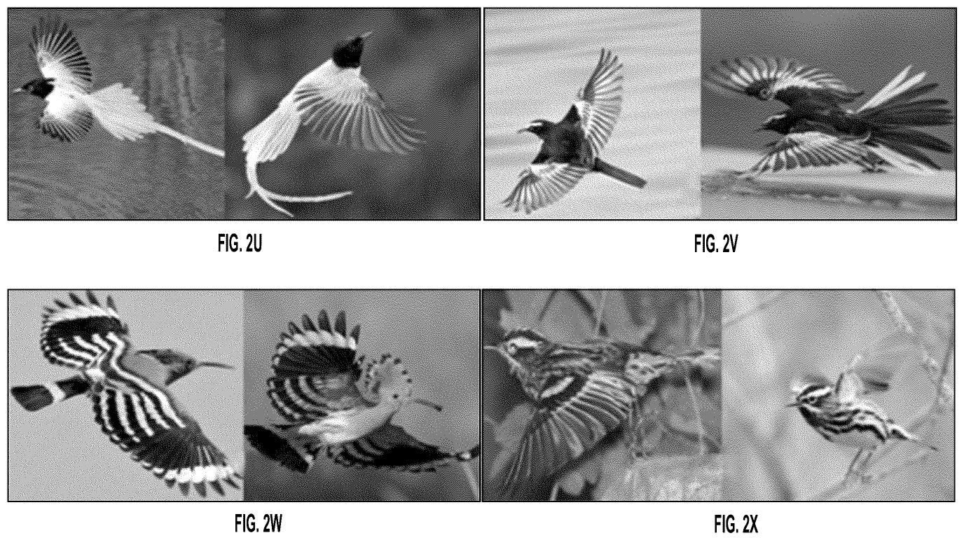

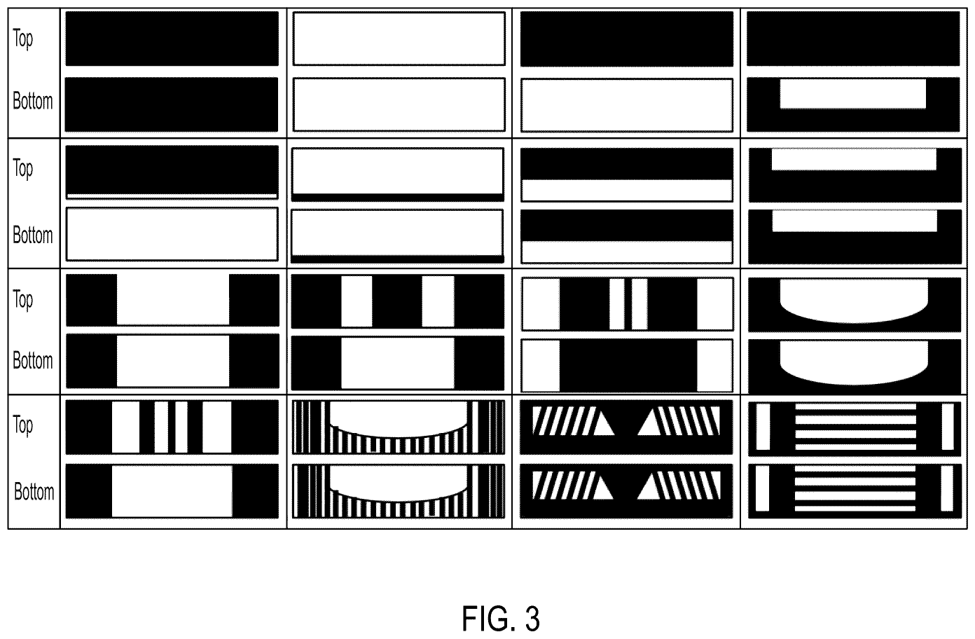

Not only is the overall coloration of a wing important, but also, the pattern of the colors presents a variation in in-flight characteristics. Birds with different flight focus, such as long versus short-range, often have different patterns. These flight patterns can vary widely both within species and across different species. FIGS. 2A-2X provide examples of several unique color patterns various birds employ. Some of these patterns are very elegant and distinct—for example the albatross (FIG. 2I), while others are more diverse and unique, as seen in the black and white Warbler (FIG. 2X). Regardless of flight objectives, each of these color patterns create unique flight characteristics due to the fluid thermal interface influenced by the temperature difference between black and white portions of the wing. In FIG. 3, different black and white coloration patterns observed on avians are shown.

In addition to coloration, there are many other characteristics of a bird that affect the flight performance and aerodynamic capabilities of the bird. Table 1, below, provides a list of several bird species with various black and white patterns. This list contains some notable characteristics of the birds that have significant effects on the type of flight these birds employ. Among these are their weight, wingspan, and aspect ratio, the latter of which is the ratio between the bird's squared wingspan and the projected wing area or the ratio of the wingspan to the standard mean chord. The wing loading is another factor to consider and is calculated by the ratio between the bird's weight and its projected wing area. It can be observed that birds with greater flight distance require higher flight efficiency to conserve energy. Two examples of this are the albatross and shearwater. These birds fly long distances, and a high wing loading value is present in comparison with the other bird species. In addition to this, a high aspect ratio allows them to improve flight performance as well as more easily take advantage of the well-documented ground effect. It can also be seen these birds have significant black and white colors as these patterns aid in reducing drag and increasing lift, requiring reduced energy expenditure, which is crucial over extended distances. An additional example is the Hoopoe and Magpie Lark; they have similar weights; however, they have different wing loading. The Hoopoe has a higher wing loading which will result in a lower wing area and a tendency to fly using higher angles of attack. This leads to the theory that any improvement in flight should be focused on high angles of attack. On the other hand, the Magpie Lark has lower wing loading, which suggests the bird flies in the lower angle of attack (“AOA”) range, and any improvement in flight should be focused on this range, which can be seen in the experimental results presented below.

TABLE 1
Characteristics of different birds with black
and white color for general comparison

| | | | | | | | Max |
|---|---|---|---|---|---|---|---|
| | | | Body | | Wing | Flapping | flight |
| | Weight | Wingspan | length | Aspect | loading | frequency | altitude |
| Bird | (g) | (cm) | (cm) | ratio | (N/m²) | (Hz) | (m) |
| Alpine | 188- | 75- | 37- | 6.40 | 21.8 | — | 8,000 |
| Chough | 252 | 85 | 39 | | | | |
| Whooper | 8500- | 218- | 145- | 8.7 | 175 | 3.44 | 8,200 |
| Swan | 10000 | 243 | 160 | | | | |
| Avocets | 260- | 77- | 42- | — | — | — | 3,000 |
| | 290 | 80 | 45 | | | | |
| Yellow- | 150- | 61 | 43- | — | — | — | — |
| billed | 170 | | 54 | | | | |
| Magpie | | | | | | | |
| Pied Crow | 520 | 328- | 46- | — | — | — | — |
| | | 388 | 52 | | | | |
| Australian | 220- | 65- | 37- | 3.1 | — | — | — |
| Magpie | 350 | 85 | 43 | | | | |
| Great | 2000- | 152 | 95- | — | — | — | — |
| Hornbill | 4000 | | 130 | | | | |
| Black- | 1100- | 130 | 65- | — | — | — | — |
| headed | 1400 | | 76 | | | | |
| Ibis | | | | | | | |
| Wandering | 5,900- | 250- | 107- | 15.6 | 150 | — | — |
| Albatross | 12,700 | 350 | 135 | | | | |
| Manx | 350- | 76- | 30- | — | — | — | — |
| Shearwater | 575 | 89 | 38 | | | | |
| White | 2300- | 155- | 110- | 7.2 | 63 | — | 4,800 |
| stork | 4500 | 215 | 125 | | | | |
| Swallow- | 310- | 112- | 50- | — | — | — | — |
| tailed Kite | 600 | 136 | 68 | | | | |
| Bearded | 4500- | 231- | 94- | 8.9 | 79 | — | 7,300 |
| Vulture | 7800 | 283 | 125 | | | | |
| Bar- | 2000- | 140- | 68- | 8.5 | 92 | 3.75 | 8,800 |
| headed | 3000 | 160 | 78 | | | | |
| Goose | | | | | | | |
| Common | 4600- | 180- | 100- | — | — | — | 10,000 |
| Crane | 5400 | 240 | 130 | | | | |
| Andean | 10100- | 283- | 100- | — | — | — | 6,500 |
| Condor | 12500 | 330 | 130 | | | | |
| Rüppell's | 6400- | 226- | 85- | — | — | 3 | 11,300 |
| Vulture | 9000 | 260 | 103 | | | | |
| Snow | 2050- | 135- | 64- | — | — | — | 3,050 |
| Goose | 4500 | 165 | 79 | | | | |
| Whooping | 4500- | 200- | 132 | 4.1 | 50 | — | 950 |
| Crane | 8500 | 230 | | | | | |
| Indian | 20- | 86- | 19- | — | — | — | — |
| Paradise | 22 | 92 | 22 | | | | |
| Flycatcher | | | | | | | |
| White- | 30- | — | 21 | — | — | — | — |
| browed | 36 | | | | | | |
| Wagtail | | | | | | | |
| Hoopoe | 46- | 44- | 25- | — | — | — | — |
| | 89 | 48 | 32 | | | | |
| Black and | 8- | 18- | 11- | — | — | — | — |
| white | 15 | 22 | 13 | | | | |
| Warbler | | | | | | | |
| Great | 670- | 105- | 43- | — | — | — | — |
| shearwater | 995 | 122 | 51 | | | | |
| Magpie | 64- | — | 25- | — | — | — | — |
| Lark | 118 | | 30 | | | | |

It has been observed in previous studies the coloration of a bird's wing can have a significant effect on both the drag and lift of the wings, creating an improvement in flight efficiency, but the effect of the pattern has not been considered. Several non-typical color patterns—for example those shown in FIG. 3, were computationally modeled using ANSYS software. These results were then compared with experimental results obtained via wind tunnel measurements of a wing with sections heated through heating wires. These wires were then activated in various groups to present various heated surface patterns. With these results, a comparison was then made to verify the hypothesis that each color pattern produces a unique aerodynamic result.

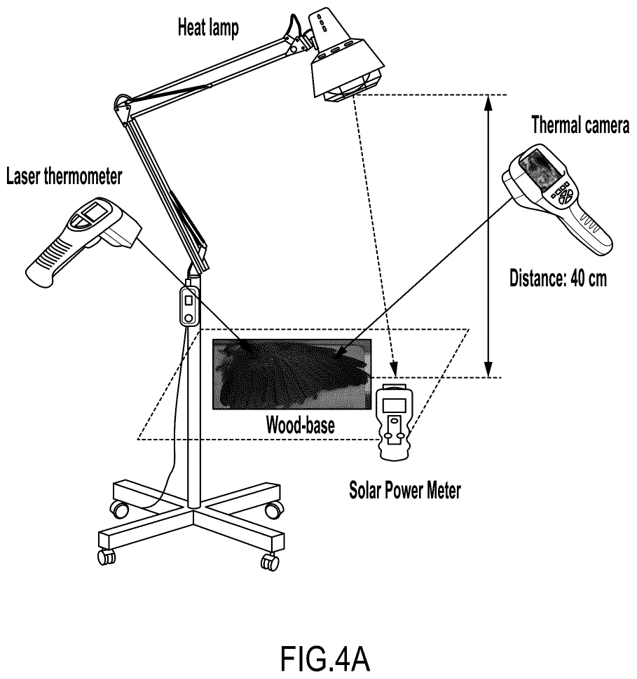

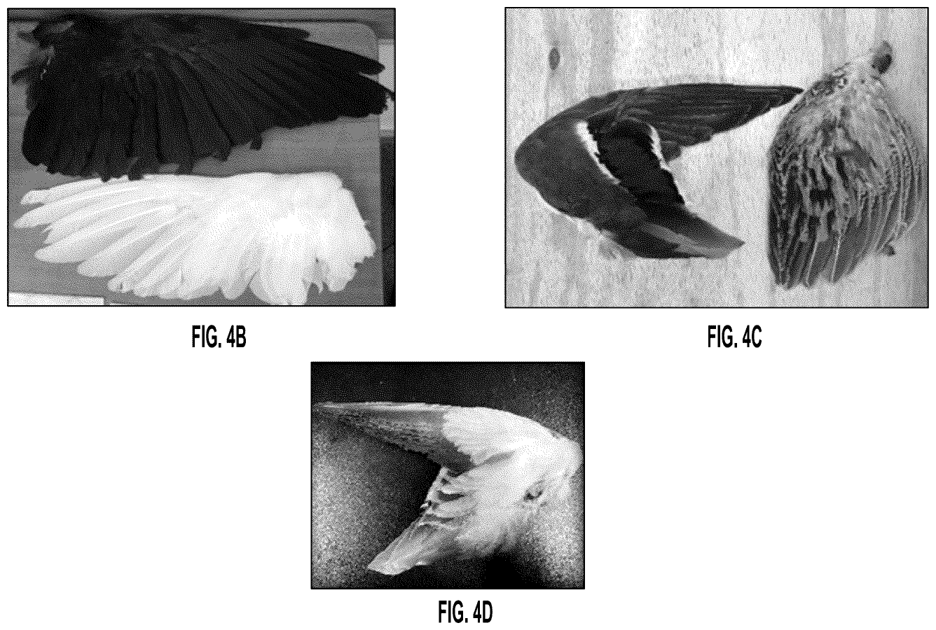

Several wings of similar size and shape were placed under a heat lamp to investigate the surface temperatures of different wing colors. The lamp was then positioned 40 cm above the STYROFOAM® surface on which the wings were placed to simulate solar radiation. The two wings were exposed to the heat lamp for 12 minutes, and their surface temperatures were measured by a thermal camera every 30 seconds. To measure the radiation of the heat lamp, an SM206 Digital Solar Power Meter Sun Light Radiation Measuring Testing Instrument was used. In FIGS. 4A and 4B, the designed experimental setup and the test wings are shown, respectively.

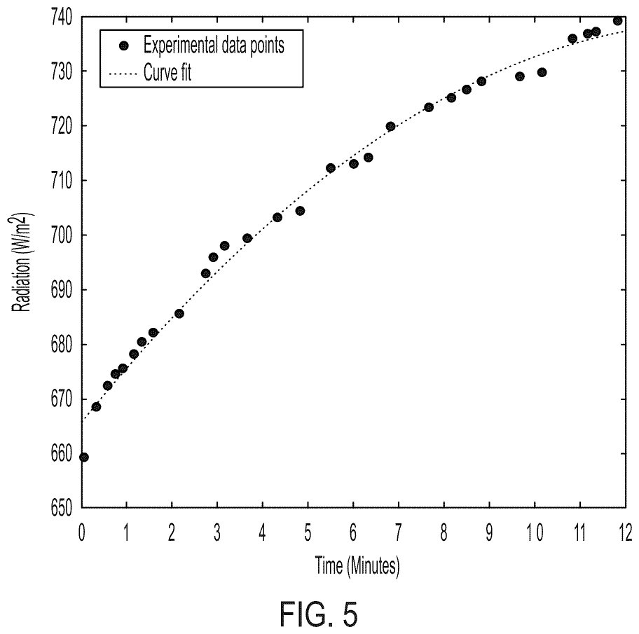

In FIG. 5, a view of the measured radiation of the heat lamp with the Solar Power Meter is shown. The results show that with increasing time, the radiation of the heat lamp increases and is similar to that of the global solar irradiance.

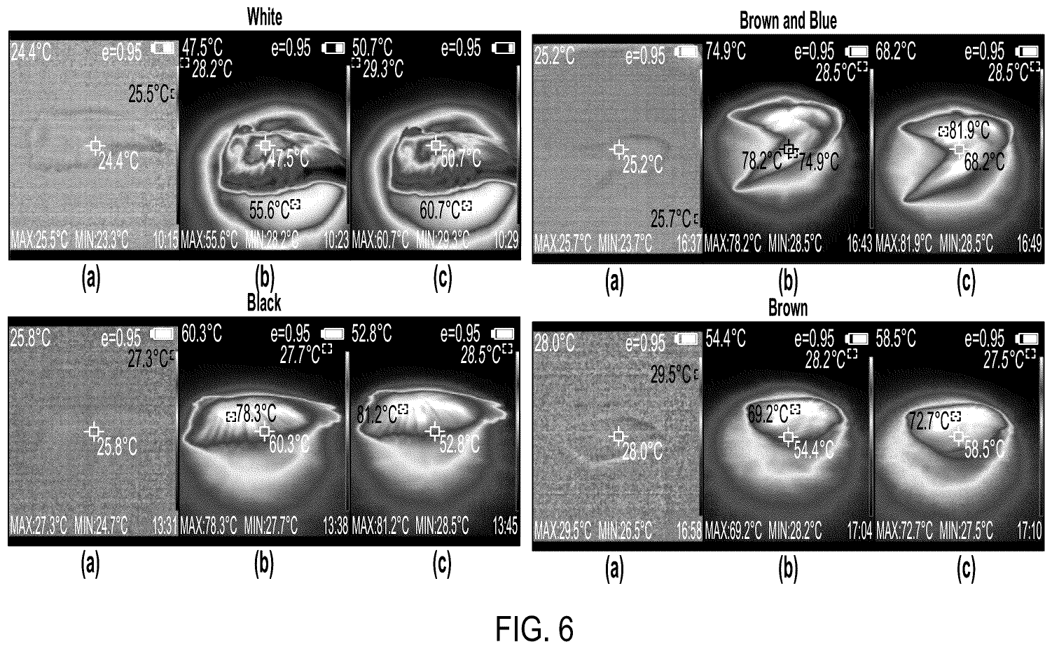

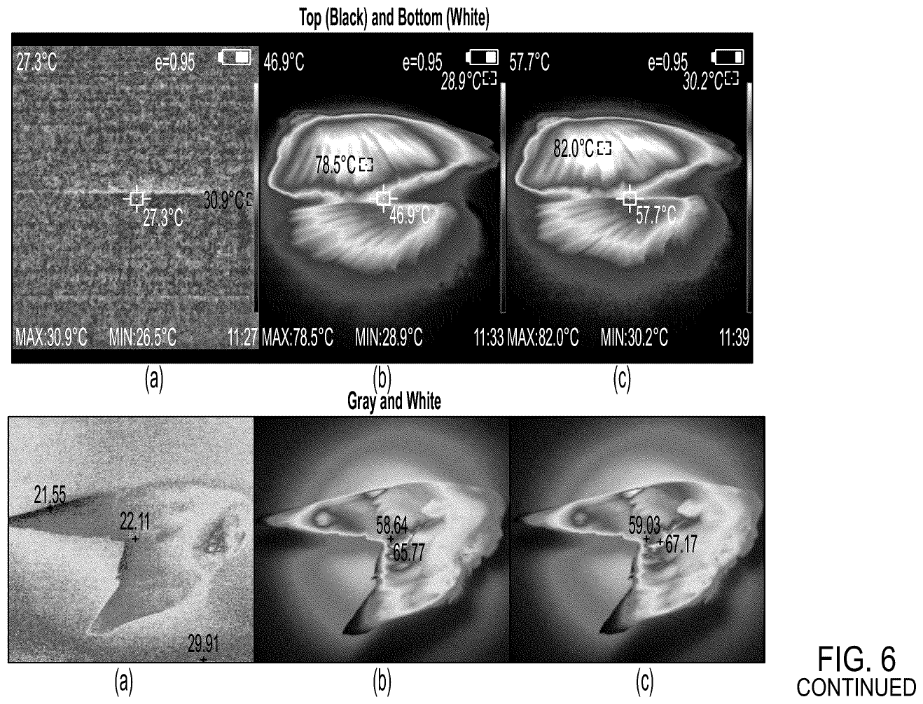

Various tests were then performed using this experimental setup on the wings following the temperature of a fully white wing under the heat lamp over 12 minutes and shows the wing reaching a temperature of 50° C. Below is a similar test using black, brown and blue, and brown wings. These wings absorbed and released more radiation and thus reached higher temperatures respectively of 81.2° C., 81.9° C., and 72.7° C. after 12 minutes. A further comparison can be seen in FIG. 6, where both black and white wings were placed under the lamp at the same time. In each of these tests, temperature measurements were taken every 30 seconds to plot the temperature distribution of both the black and white wings. It can be observed there was a substantial temperature variation between the black and white wings leading to the hypothesis that various patterns will produce unique aerodynamic signatures.

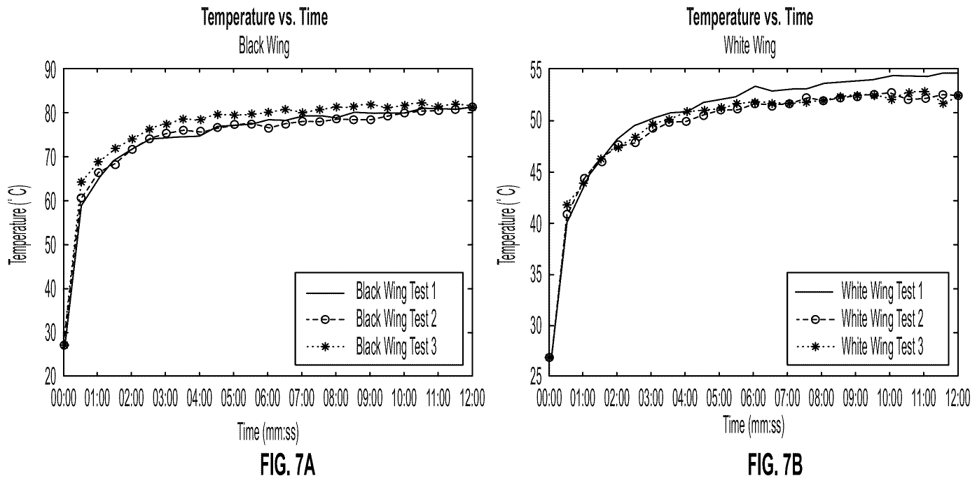

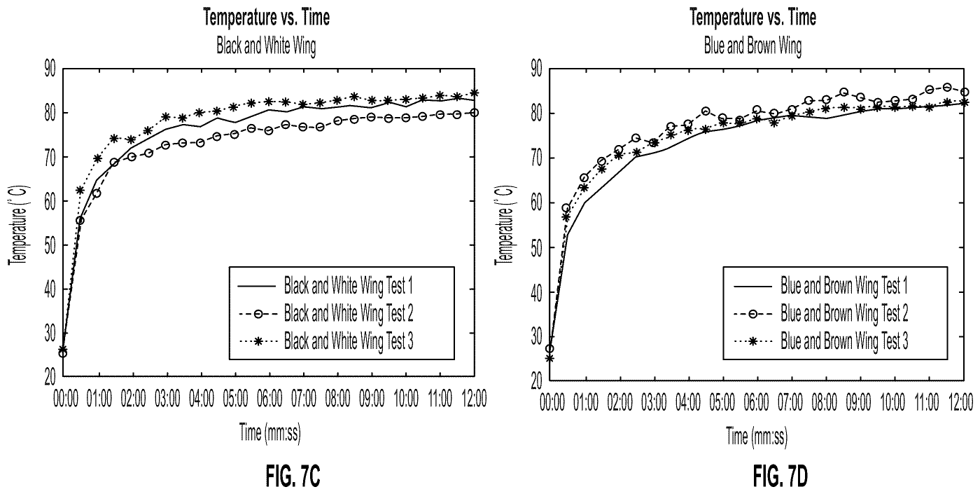

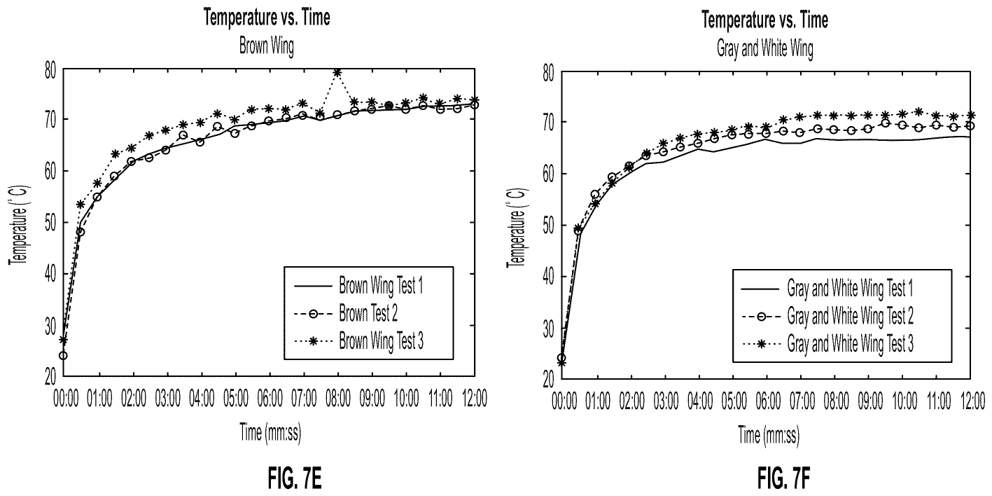

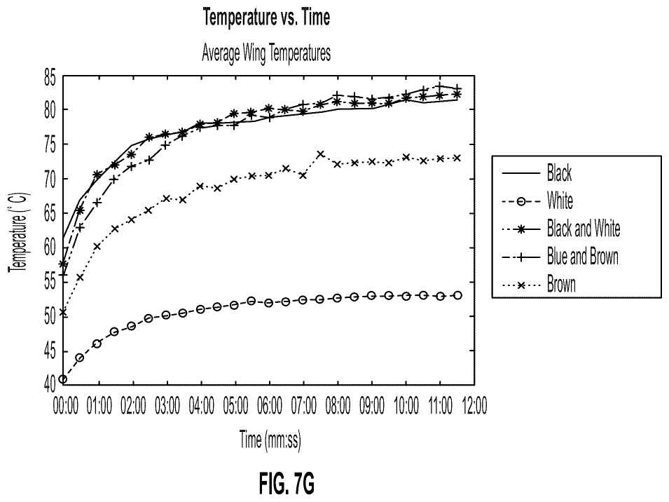

The maximum temperatures over time for these wings are plotted in FIGS. 7A through 7F, respectively, based on the recorded maximum temperature from the thermal images. The average temperatures between the wings were then compared in FIG. 7G to display the vast temperature difference between the various wing colors. The gray and white case was added to the experimental study at a later date and used the same general setup, although several aspects changed and thus this wing is not included in the comparison shown in FIG. 7G. The dark gray and white contrast in a two-tone configuration was added instead of a zebra pattern and still showed the temperature change with color, although not in as interesting of a manner as a zebra pattern likely would have. It should be noted that most of the trailing edge of this wing is the dark gray color and this pattern is commonly seen in nature and is further discussed below. The maximum average surface temperature reached for the black and white wings was 81.3° C. and 53.1° C., respectively, and the median percent increase in surface temperature from the white wing to the black wing was 52° C. This result displays how drastic a temperature gradient can occur on a bird's wing due to black and white color patterns.

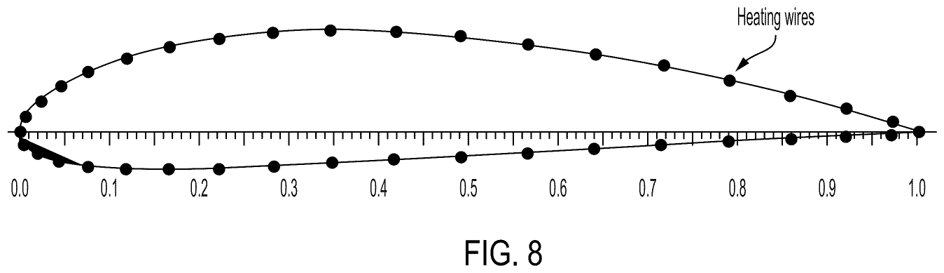

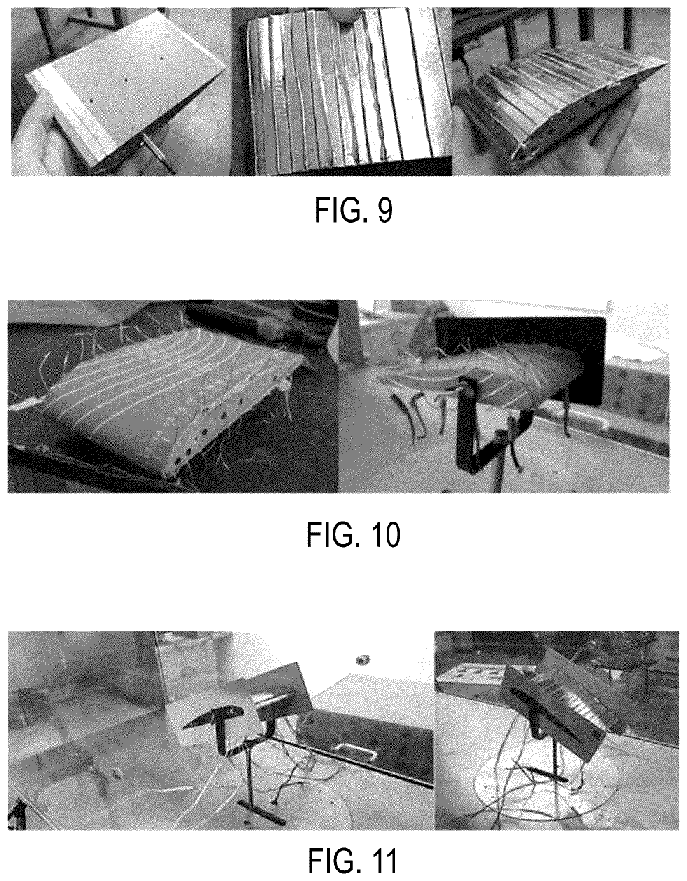

In this experimental study, a wing with a NACA 4415 airfoil was used to investigate the heating effect on aerodynamics. The wing was manufactured from a single piece of wood and constructed via a computer numeric controlled (“CNC”) router. This wing was created with a wingspan of 100 mm and a chord length of 160 mm. Nickel chrome wires (heater wires) of 0.05 mm diameter were placed across all the airfoil surfaces, allowing specific regions of the wing to be heated as shown in FIG. 8 and the construction installation process is shown in FIG. 9. Using the CNC machined wing, a metallic tape was applied to the surface to avoid burning the wooden surface. Finally, a silicone layer was adhered to all surfaces to ensure they were smooth and evenly distributed the heat to the desired area (see FIG. 10). Two metal plates were then placed on the wingtips to reduce the 3D flow effects. The insulation of the wing and its silicon covering in the wind tunnel are shown in FIG. 11.

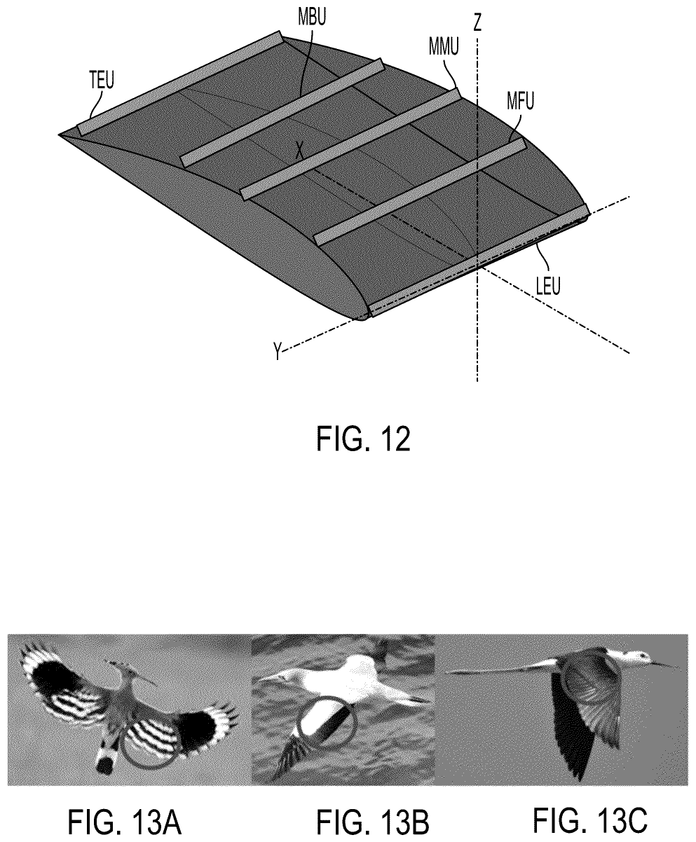

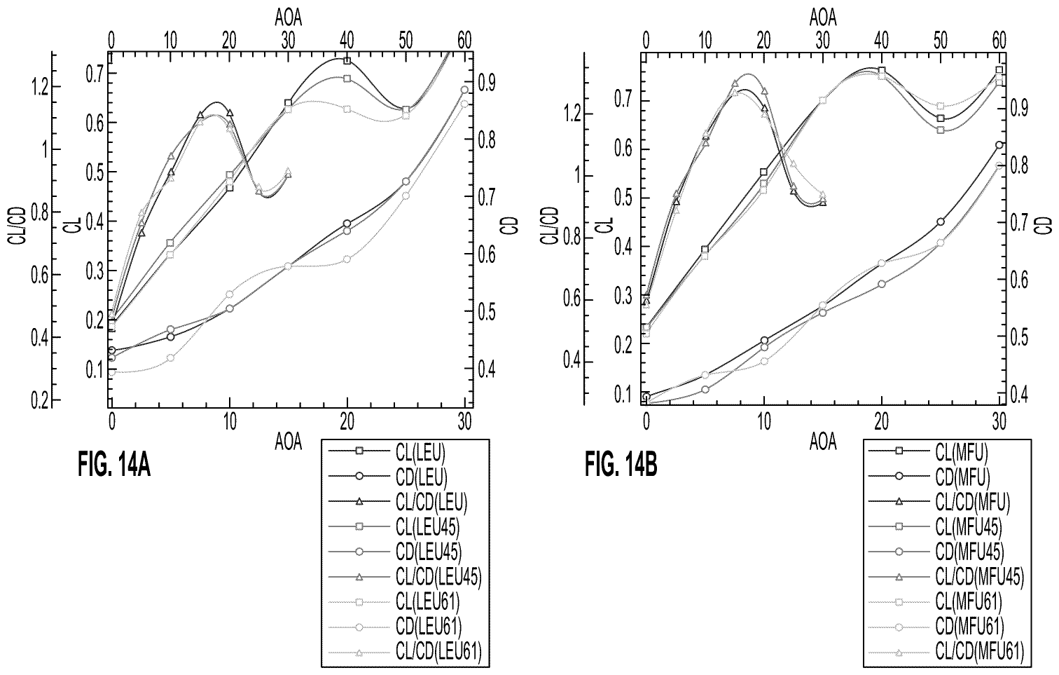

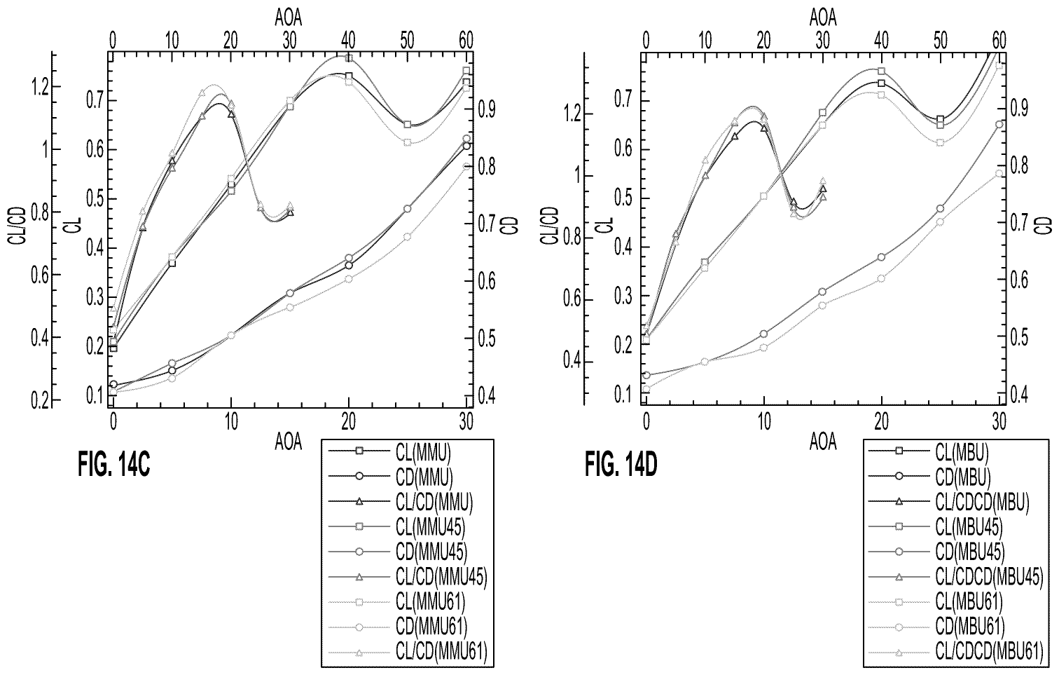

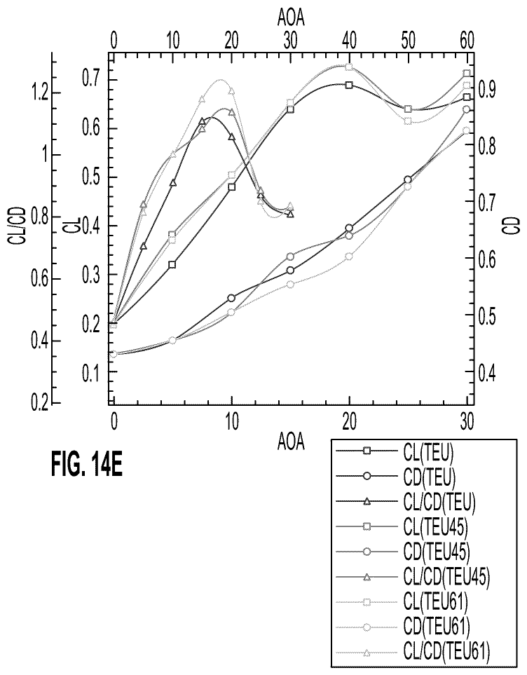

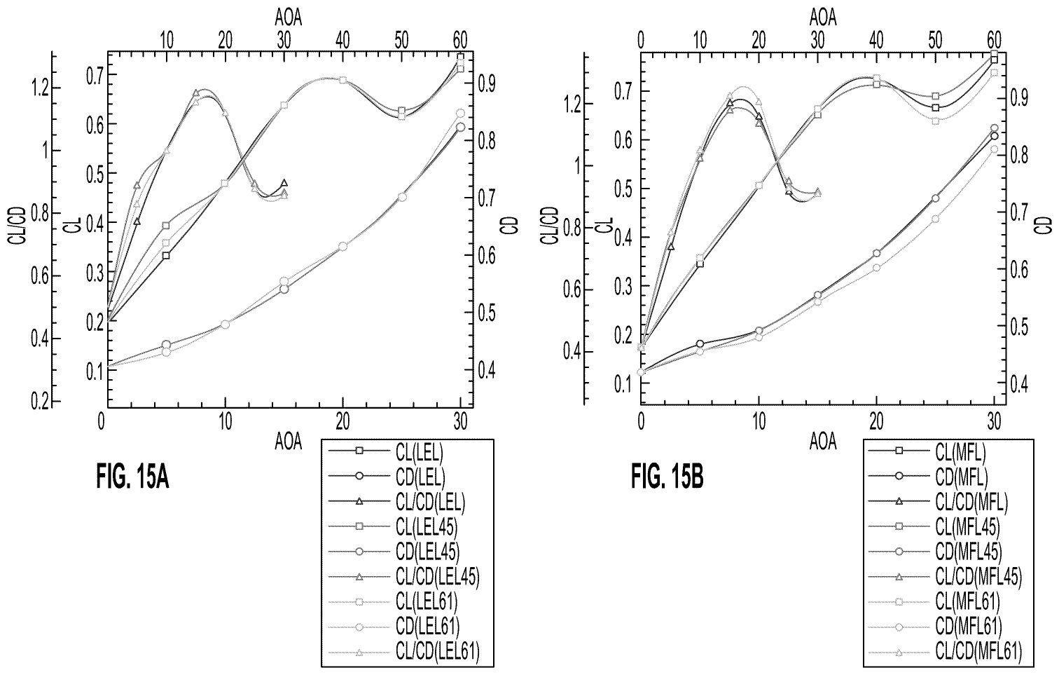

A list of the tested heating configurations with their description is shown in Table 2. The heating wires were collected in 10 groups to reduce the number of experiments conducted, as shown in FIG. 12 with the group names. Only the upper surface groups are shown, but experiments were also run with similar groups for the lower surface. Each group was heated to 45° C. and 61° C. to investigate the effect of different temperatures for each heating location. A Temperature difference of about 10° C. was chosen. The experiment was conducted for a wind speed and temperature of 9 m/s and 34° C., respectively. The AOA for each test varied from 0 to 30 degrees in 5-degree increments. The lift, drag, and surface temperature were measured throughout the experiments. Finally, three cases from real bird's wing color patterns were tested. These bird wing color patterns are shown in FIGS. 13A, 13B, and 13C. The names of these patterns in the results of the experiments are Hoopoe, TEU-MBU, and upper, respectively.

TABLE 2
A list of the tested heating configurations with their description.

| Heating zone | |
|---|---|
| name convention | Description |
| LEU | Leading-edge upper |
| MFU | Middle front upper |
| MMU | Middle middle-upper |
| MBU | Middle back upper |
| TEU | Trailing edge upper |
| LEL | Leading-edge lower |
| MFL | Middle front lower |
| MML | Middle middle-lower |
| MBL | Middle back lower |
| TEL | Trailing edge lower |
| TEU-MBU | Trailing edge upper and middle back upper |
| Zebra | Hoopoe based heating stripes |
| Upper | All upper heated |

The following represent the experimental results for the different heating regions, including the real pattern cases. In each figure, the heating cases for no heating (34° C.), 45° C., and 61° C. are compared. For clarity, each heating zone was separated into a separate plot. The cases in which no heating was applied have been plotted in blue with a room temperature of 34° C., the 45° C. cases in red, and the 61° C. in green. To reduce the number of figures, the lift coefficient, drag coefficient, and lift to drag ratio versus AOA have been placed in a single plot for each case using square, circular, and triangular symbols, respectively. These plots were then further broken down into three sections for ease of viewing.

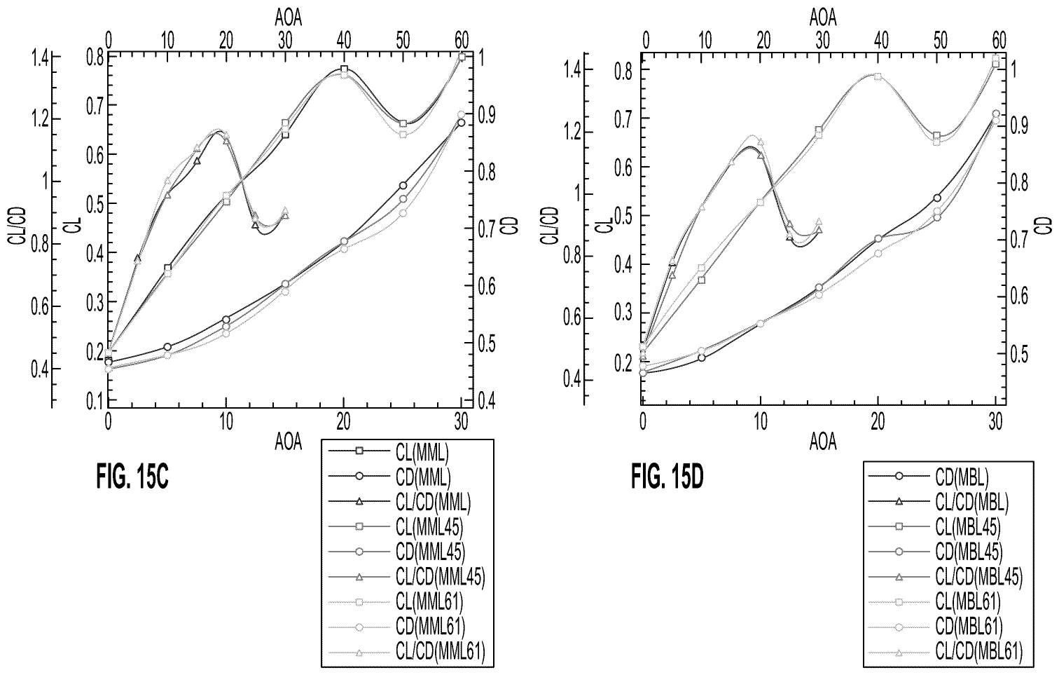

As expected, heating the lower surface did not produce a significant effect on the aerodynamic performance (see FIGS. 15A to 15E). In all cases, there was little change in the lift curve except the stall range in the MFL case and the low AOA region for the LEL case. Overall, a little positive effect was achieved for drag reduction, especially for the MFL case at 60° C.

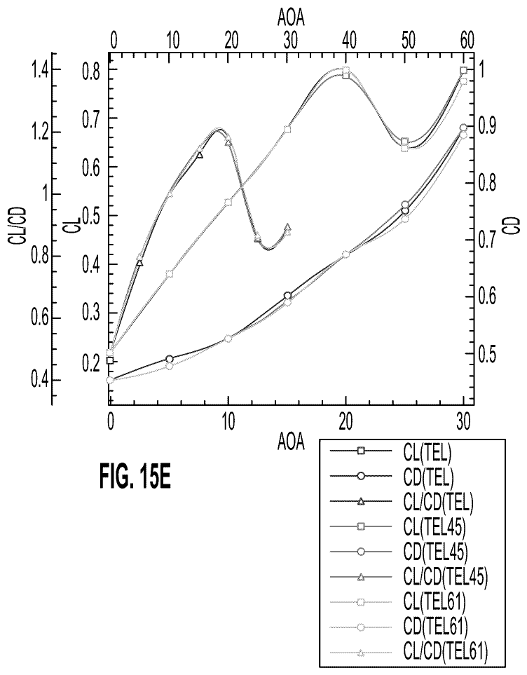

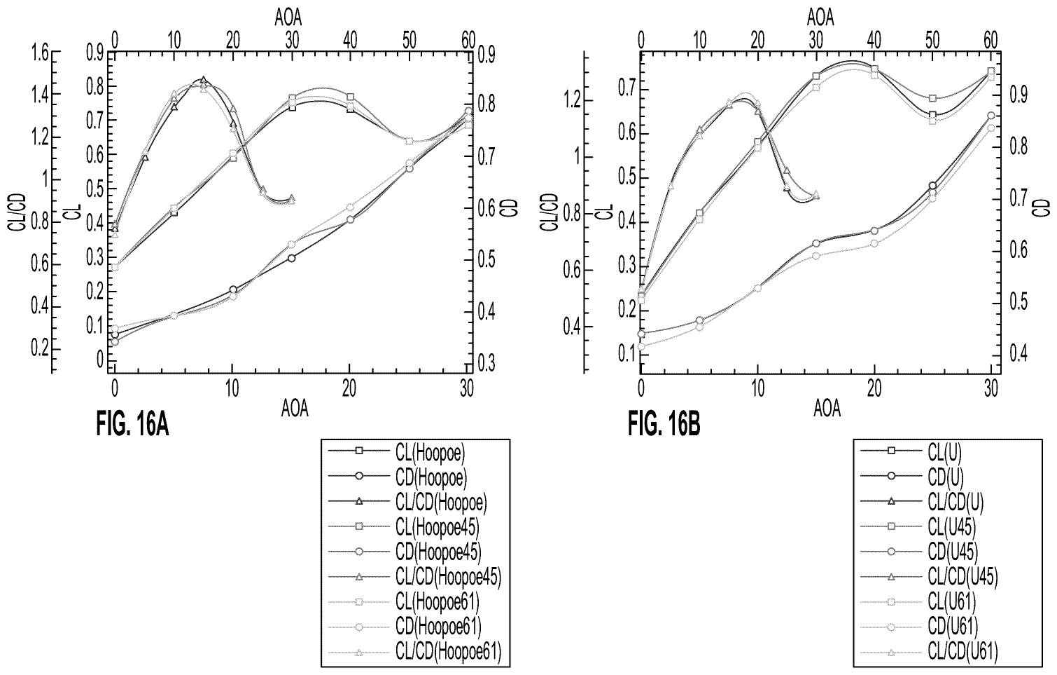

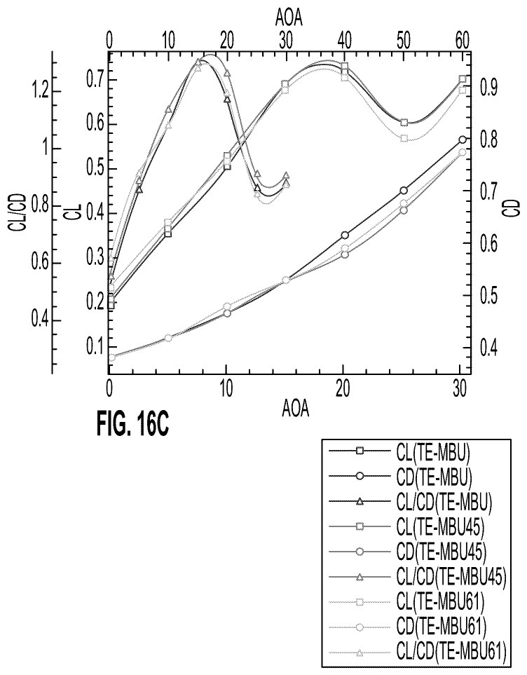

An improvement was observed in the lower AOA range, which is suitable for birds with higher wing loading that fly faster and with lower angles of attack. The final scenario tested was heating the entire upper wing surface, mimicking an all-black color pattern. This investigation resulted in few significant improvements. There was a minor improvement in drag reduction in high AOA with a reduction in the lift for the 65° C. cases. In FIGS. 16A to 16C, the lift, drag, and lift to drag versus AOA for non-heated and heated (45° C. and 61° C.) scenarios for zebra pattern, upper heated, and trailing edge upper and middle back upper are shown, respectively.

The results shown below are a tabulated collection of the percentage change in the relevant aerodynamic coefficients: C_{L}, C_{D}, and C_{L}/C_{D}. All of the experimental results for comparison against the unheated case are included for reference. It should be noted that not all cases presented any significant change in performance and some cases negatively affected the flight performance. Only the significant results are further discussed below.

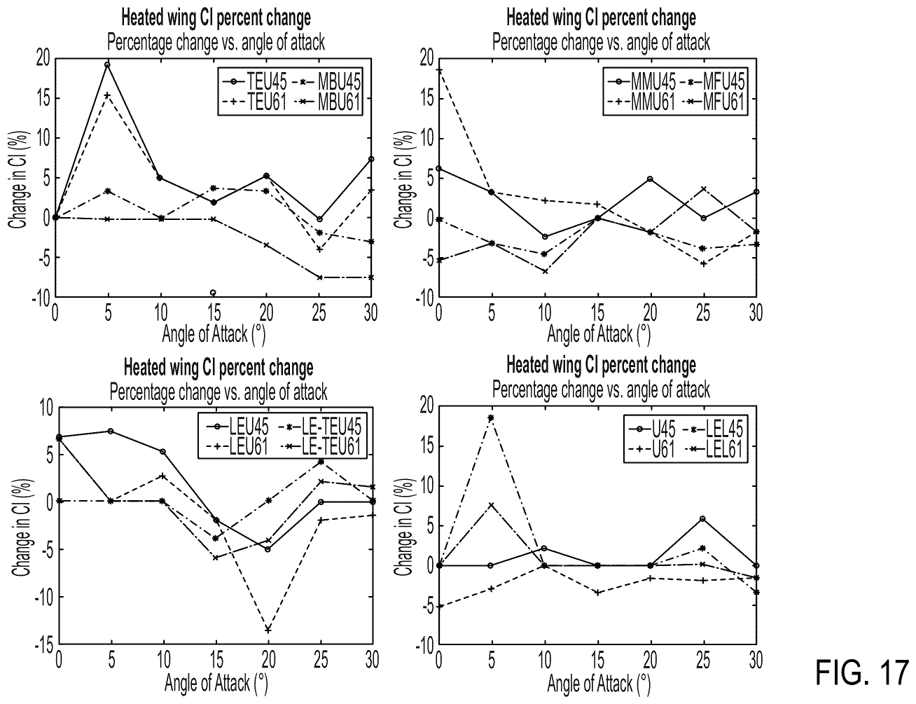

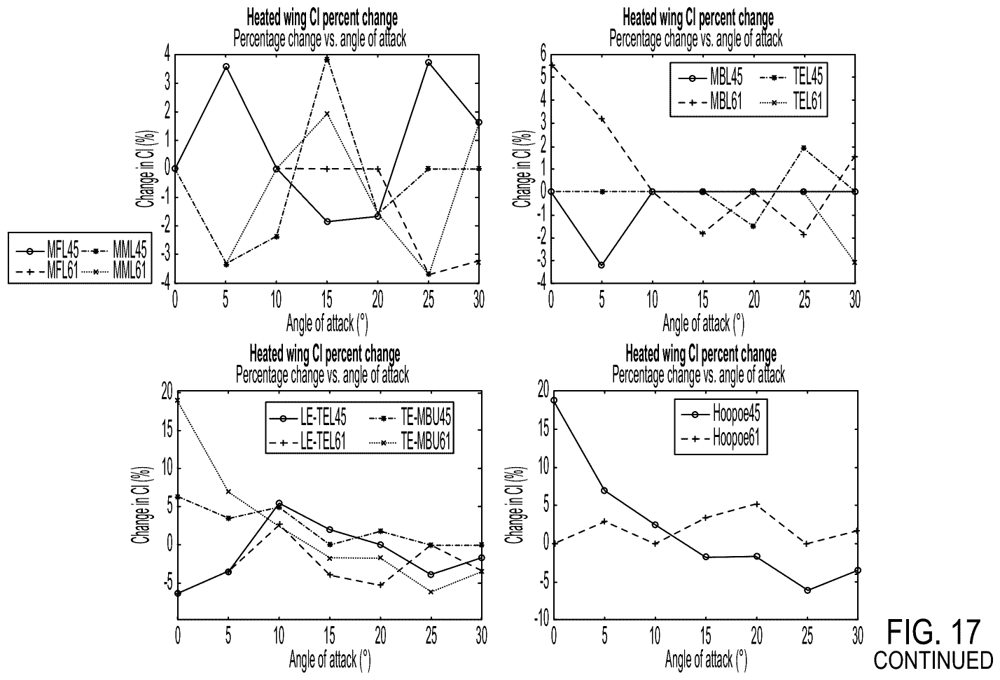

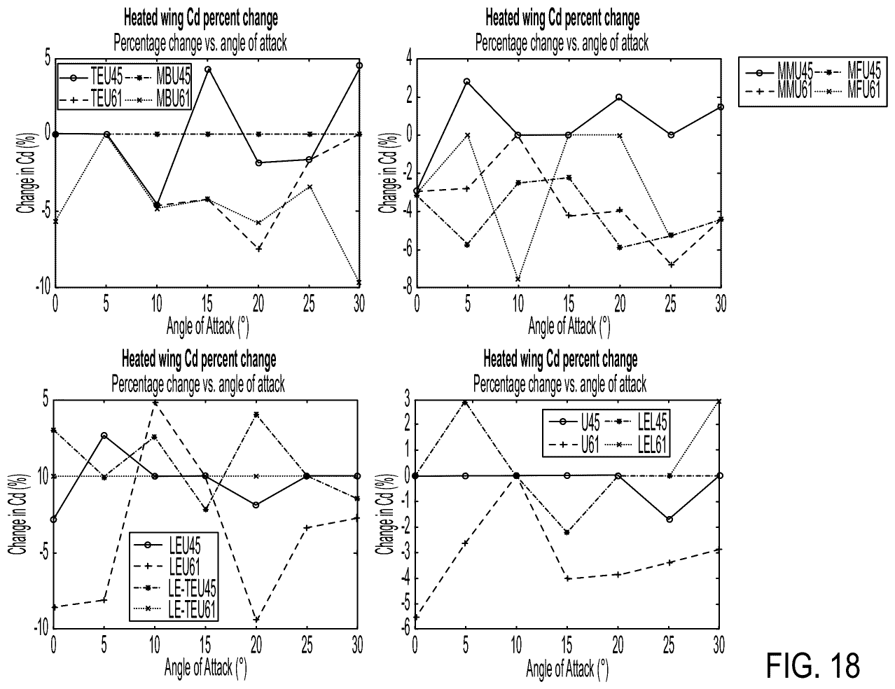

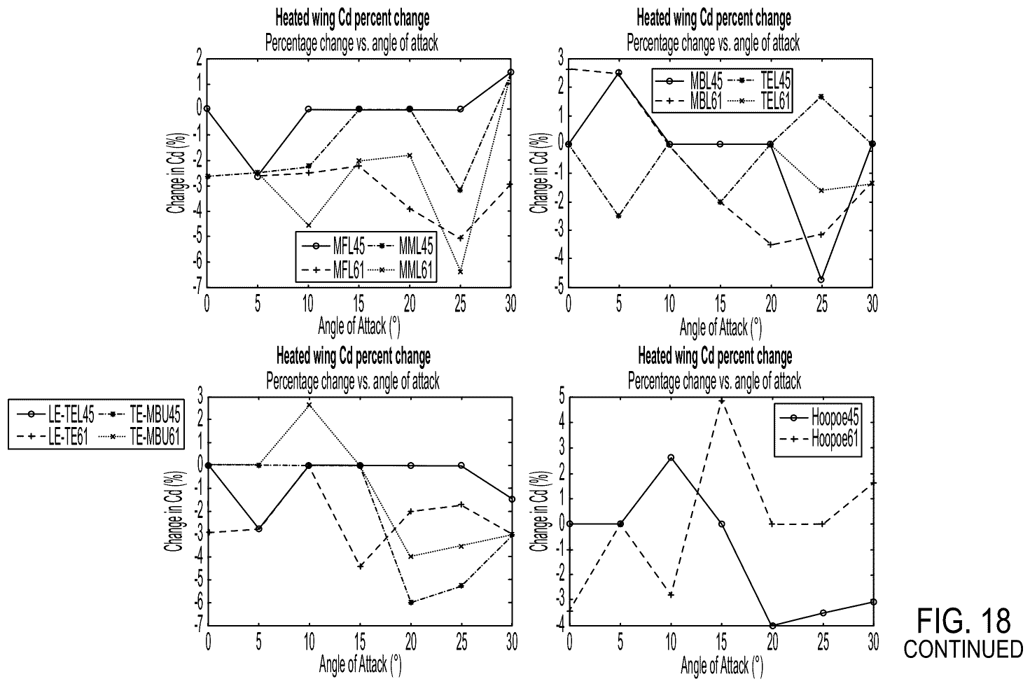

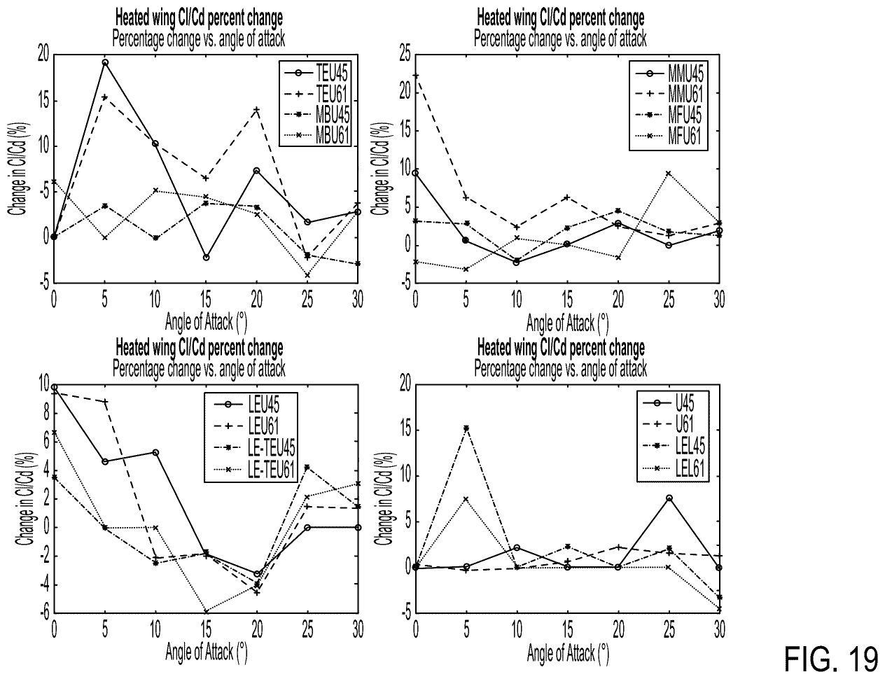

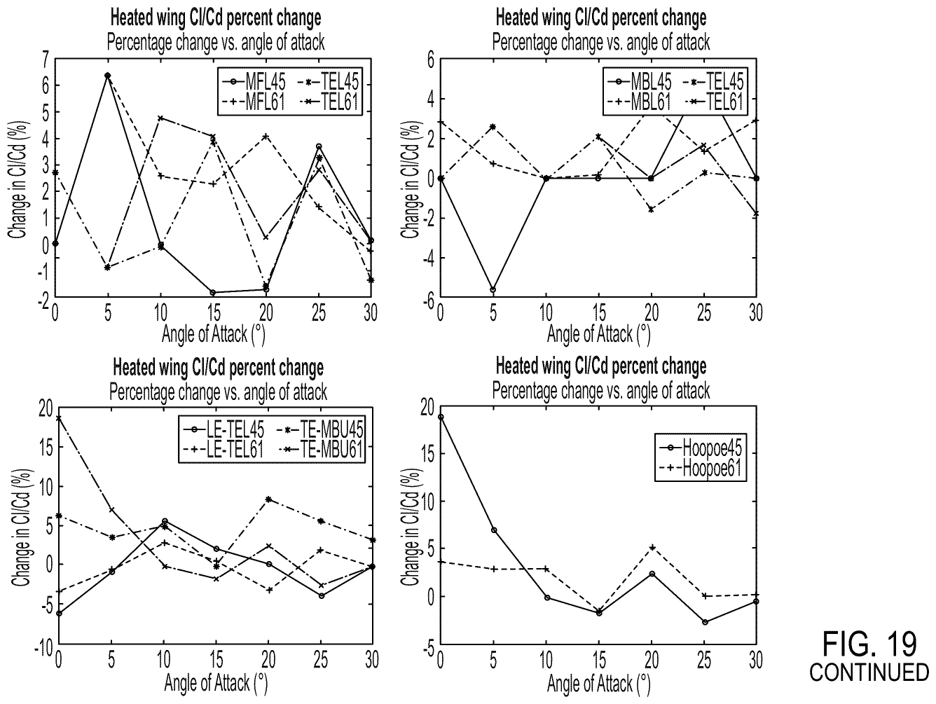

The cases in which the front and middle-upper portions were heated provided the greatest increase in lift while maintaining little change in drag performance for low AOA. This increases the overall flight efficiency as more lift is generated for the same free stream velocity. The lift to drag ratio benefitted by as much as 10% for these cases; a similar case exists for the lower leading edge and combinations of these configurations. The lower heating cases had less of a performance improvement. However, the MBU-TE cases and the Hoopoe-inspired case also provided significant performance improvements. In FIGS. 17 to 19, the changes of lift, drag, and lift to drag ratio coefficients for each heating case versus the unheated measurement are shown.

Some of the experimental data collected in these trials are sporadic and should not be taken as absolute. In these initial tests, high-fidelity experiments were not conducted to produce exact results; however, they provide support that a unique color pattern produces a unique aerodynamic signature. The zebra stripe pattern of the Hoopoe, along with the heating of the leading edge upper, trailing edge, and middle middle-upper, have provided significant results.

To further investigate the heating effects on the aerodynamic performance of the selected wing, a comparison between heating cases and the heating location was performed for fixed angles of attack incrementing by 5°. This is a rudimentary analysis and only aims to provide some insight into the unique effects of various heating locations over a wing's surface. A higher fidelity study will allow better determination of the unique effects for each heating location and will allow the categorization of various patterns to improve aerodynamic efficiency for different use cases. It is also possible that certain patterns may be desired to decrease efficiency in certain scenarios, such as reducing the lift experienced by a vehicle, or to improve braking time by increasing the drag.

The following plots are broken into three groups comparing percentage change in lift, drag, and lift/drag for each heating case against the heating location. Each plot contains two different heating cases (45° C. and 61° C., as previously discussed), with the upper and lower heating locations plotted separately to provide a comparison between the unique effects and how they change as the location varies.

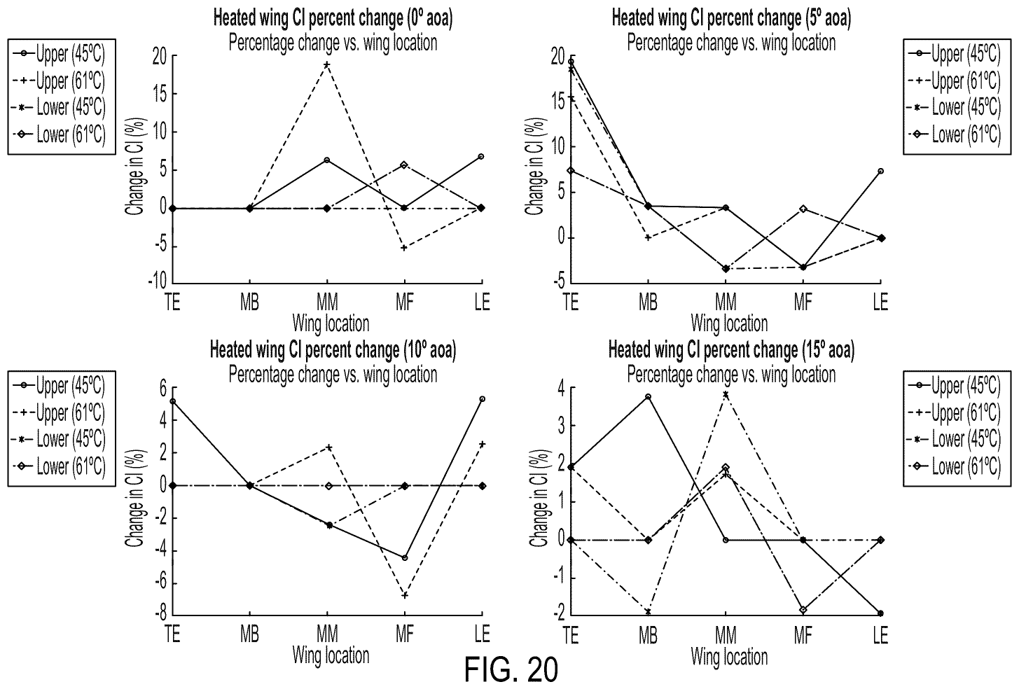

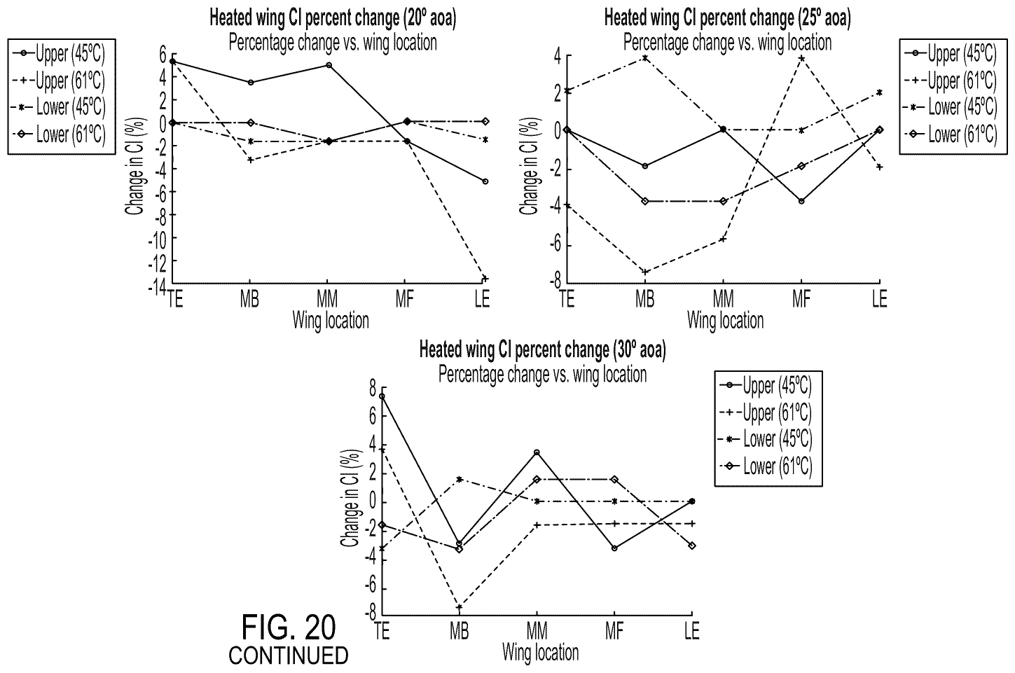

For example, the low AOA cases in FIG. 20 showed a 20% increase in lift for the MMU 61° C. heating case for 0° AOA. Similarly, the 5° cases display an increase of between 7% and 20% for all the heating cases on the trailing edge. This seems to quickly drop off as the heated location moves toward the leading edge. Increasing the lift coefficient at the low AOA is very helpful for high aspect ratio wings and high-speed flight, which tend to fly at a low AOA. Generally, it would be very good for cruise flight performance. As 20° is the angle for maximum lift, heating TE and MM on the upper surface with 45° could increase the maximum lift coefficient by about 6%, and they are the highest values compared with all the other cases. This is very helpful to lower stall speed and the minimum flight speed. Generally, reducing the stall speed would decrease take-off distance. So, if the selection would be made based on the lift point of view, it would be painting the trailing edge of the wing with a dark color to improve the cruise, the stall and minimum flight speed. Of course, these selections are for the mentioned Reynolds number only, and further investigations should be done for different Reynolds numbers.

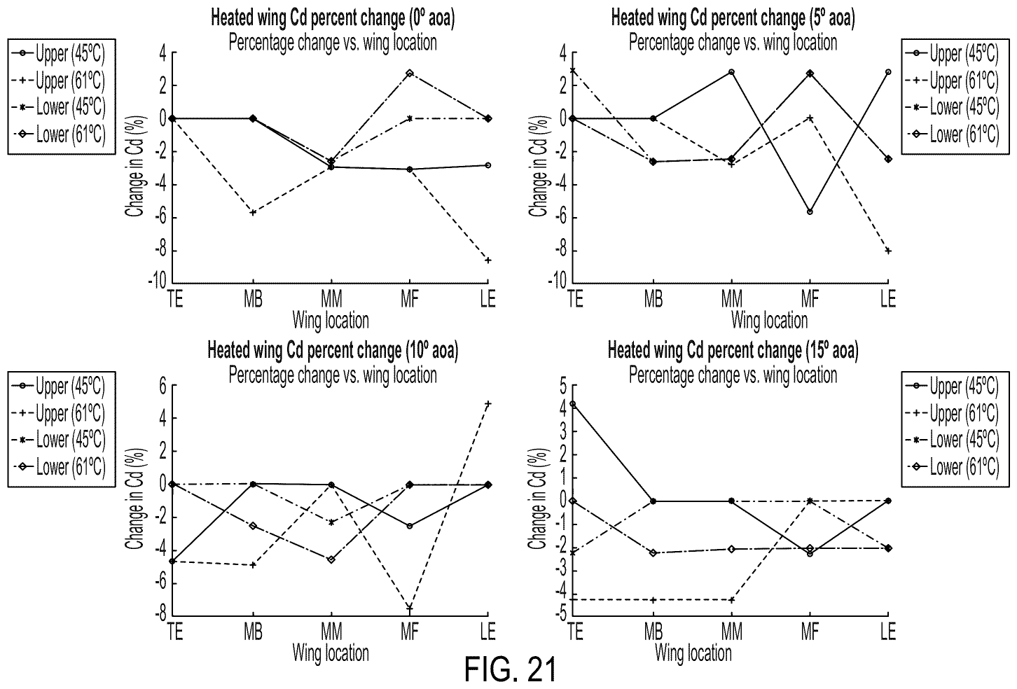

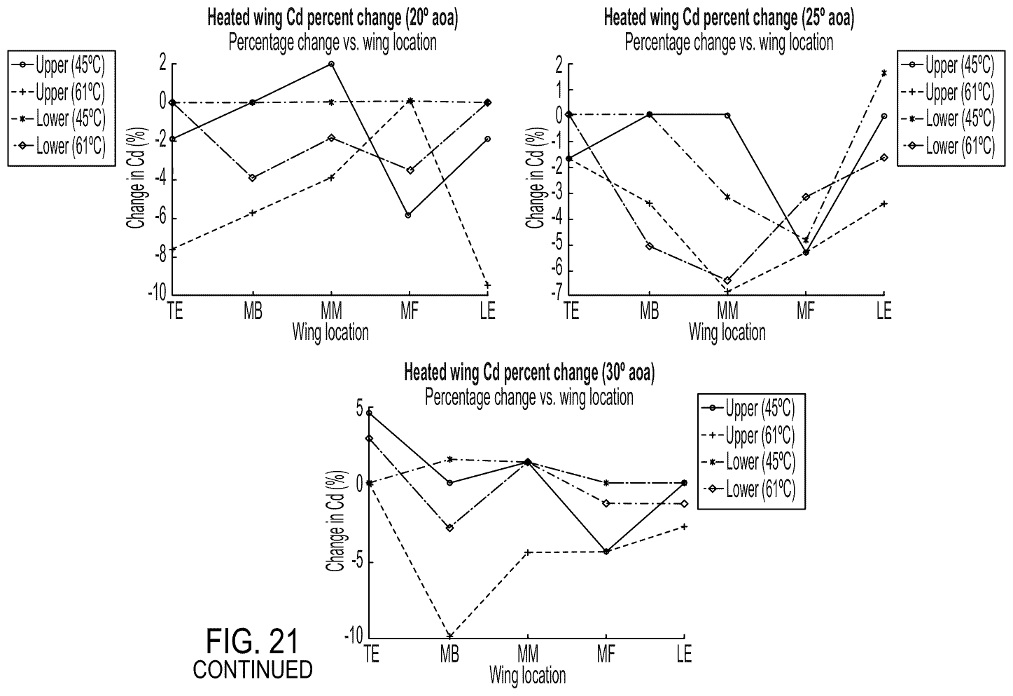

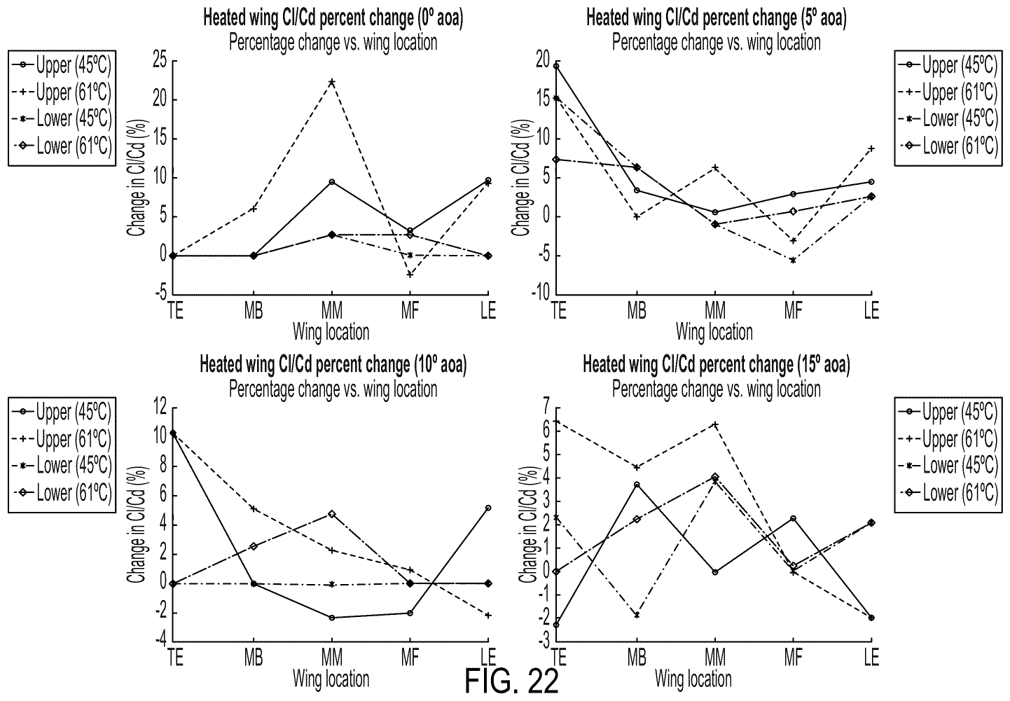

From a traditional standpoint, a reduction in drag is generally the desired outcome of design changes; however, this is not always the case. For example, when landing a plane, an increase in drag is desired to help slow to plane to a safe speed for taxiing. For this reason, both the increased and decreased drag percentages are of interest. As shown in FIG. 21, the application of heat for all locations with the exception of the trailing edge, provided a reduction in drag, leading to the possibility for more efficient level flight. In the high AOA region (about) 25° there is a significant reduction in the drag when the middle regions are heated. This is present in all of the heating cases, although strongest in the upper and lower cases heated to 61° C., indicating a capacity for high AOA use. The medium-high AOA region also presents similar results.

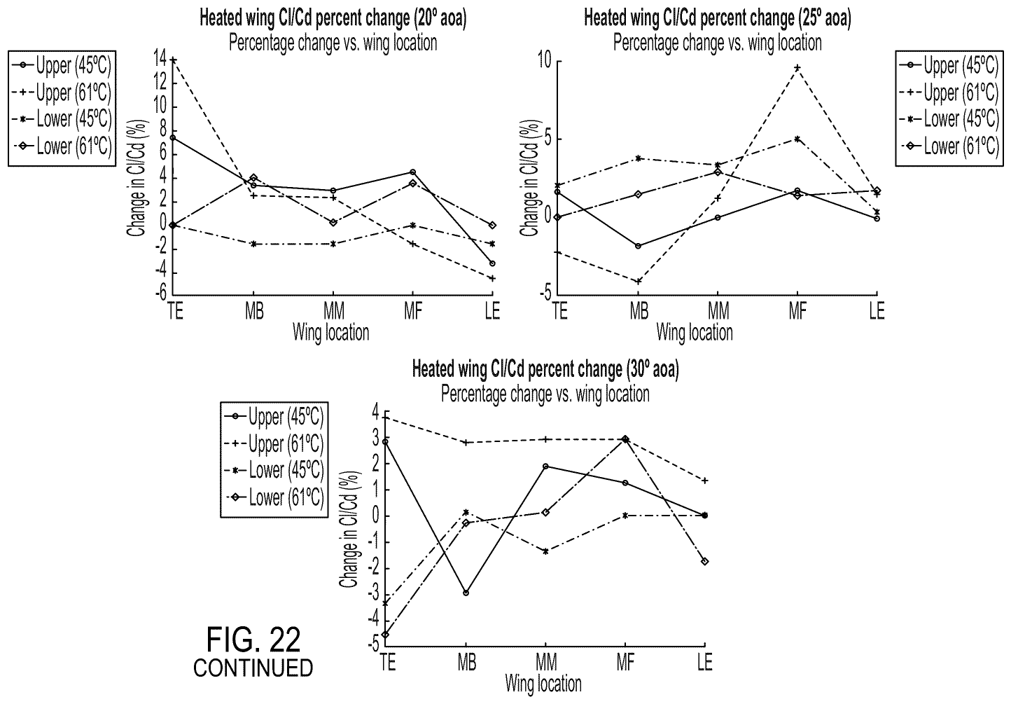

The lift-to-drag ratio is a very important parameter in determining the flight range. In other words, increasing the lift-to-drag ratio increases the flight range. The comparison of lift to drag ratios along the wing chord provides several results of interest, as shown in FIG. 22, particularly in the low to mid AOA region. For a zero AOA, the MM heating case at 61° C. provides a 25% increase. In the 5° AOA case, both temperatures for lower and upper heating provide between a 7% and 20% increase in the lift to drag ratio at the trailing edge of the wing and generally maintain an increase between 0 and 5% for the other heating locations. The 10° AOA results in a similar pattern, although the percentage increases are lesser and peak at 10% for the trailing edge.

Across all angles of attack and heating locations, the upper heating generally results in a greater percentage change than the lower surface heating. This is not to say the lower heating is not useful as it can produce the opposite effect as the upper heated surface under certain conditions, making it useful in the counter cases where a reduction in lift or increase in drag may be desired. Overall, the flight cruise is at a low AOA; increasing the flight range can be achieved by increasing the lift-to-drag ratio. Based on results and on the cruising AOA upper MM or TE of the wing should be painted with a dark color to increase the flight range.

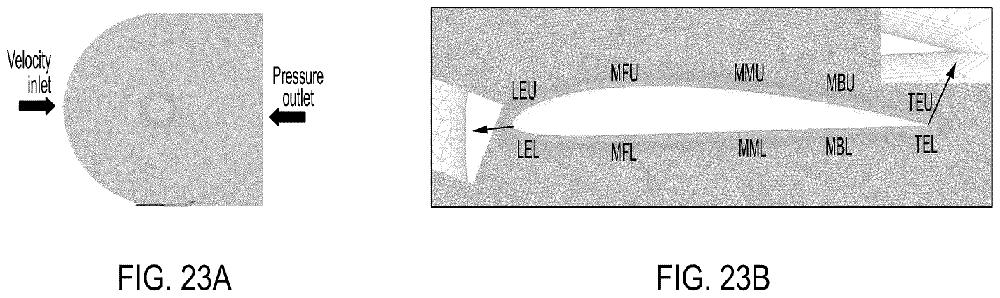

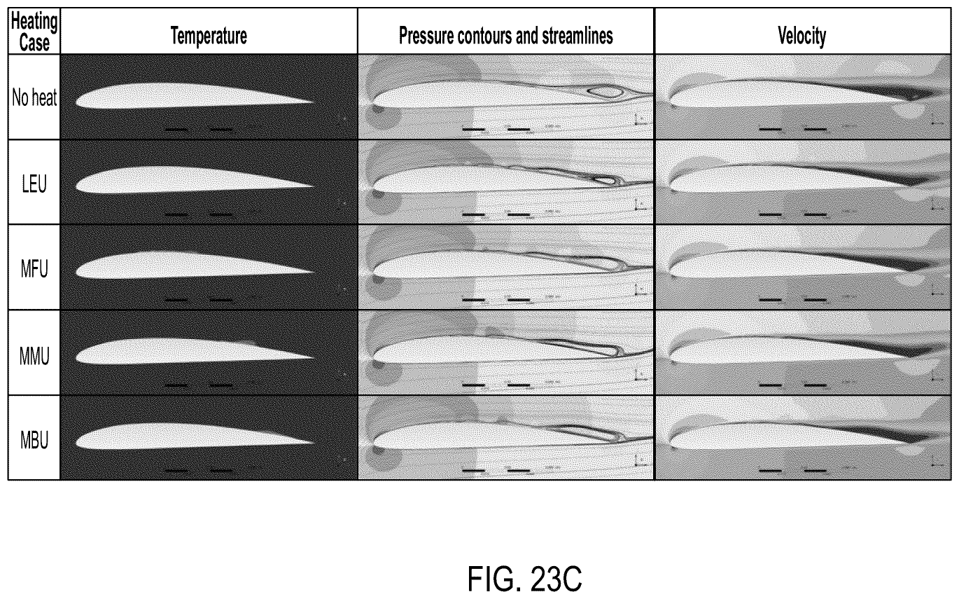

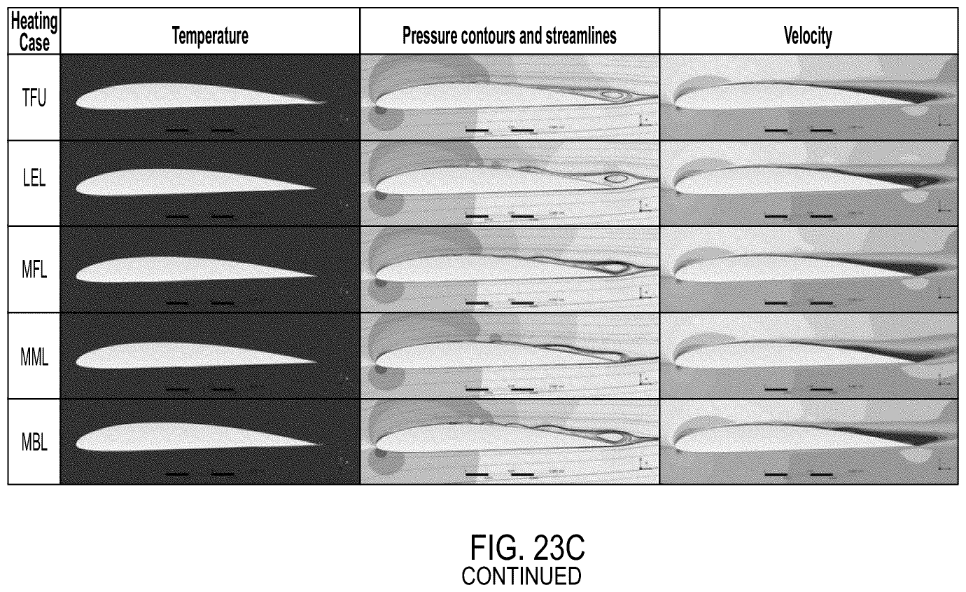

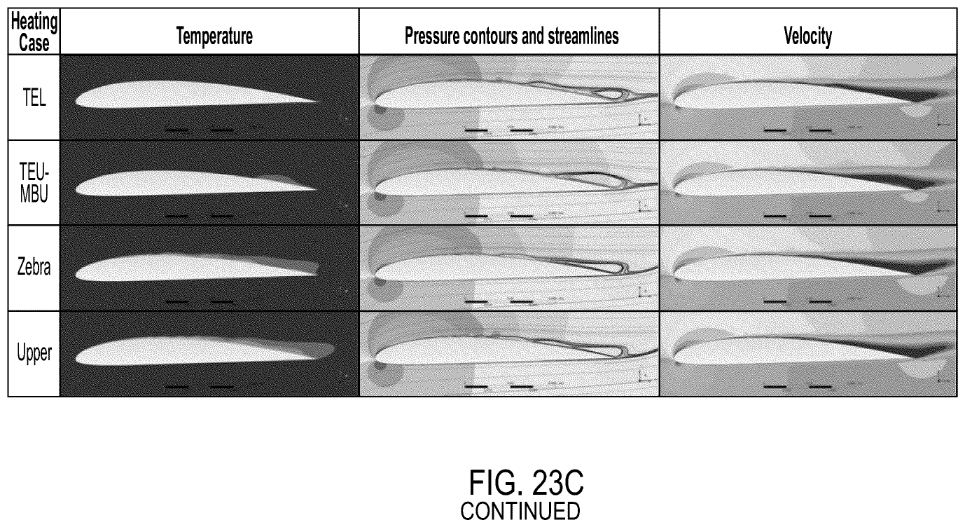

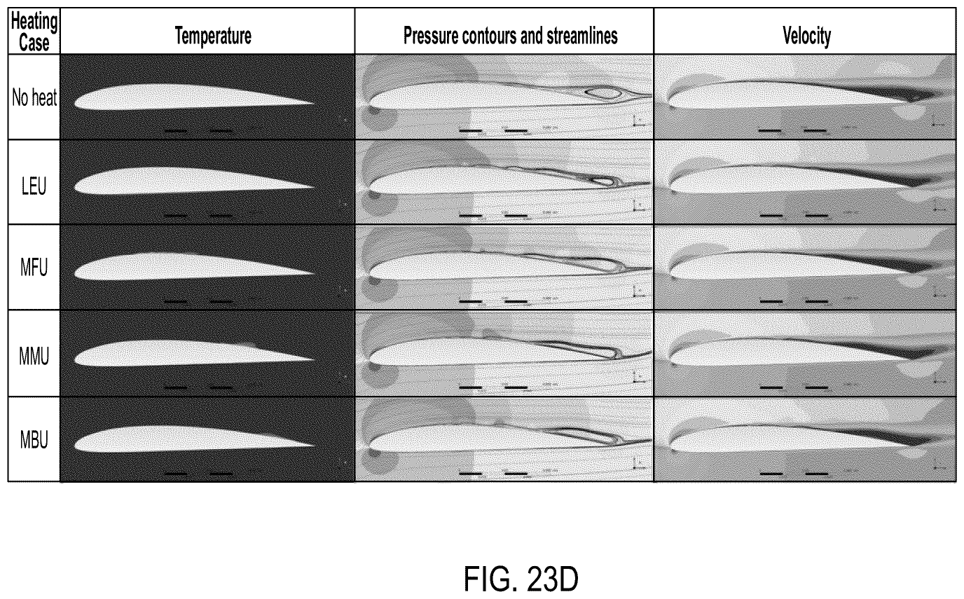

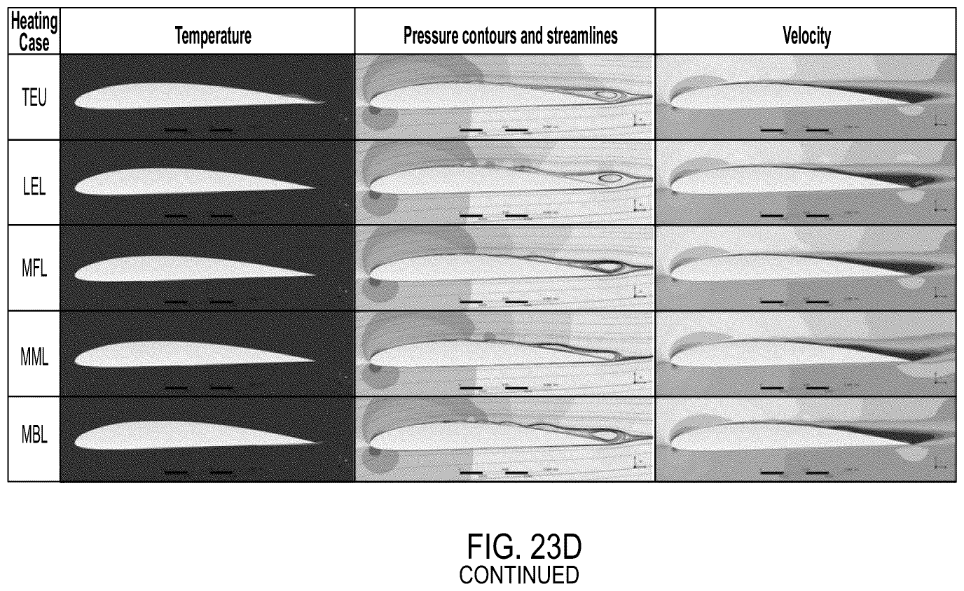

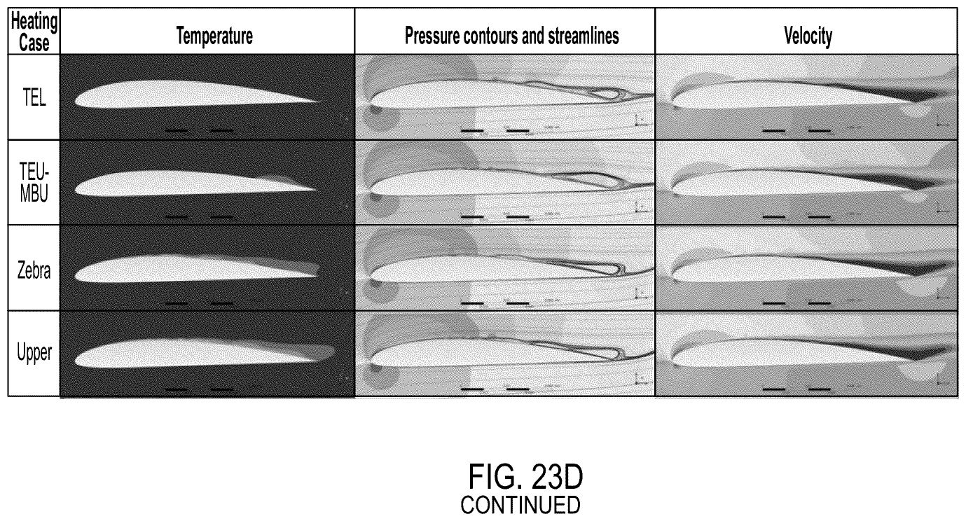

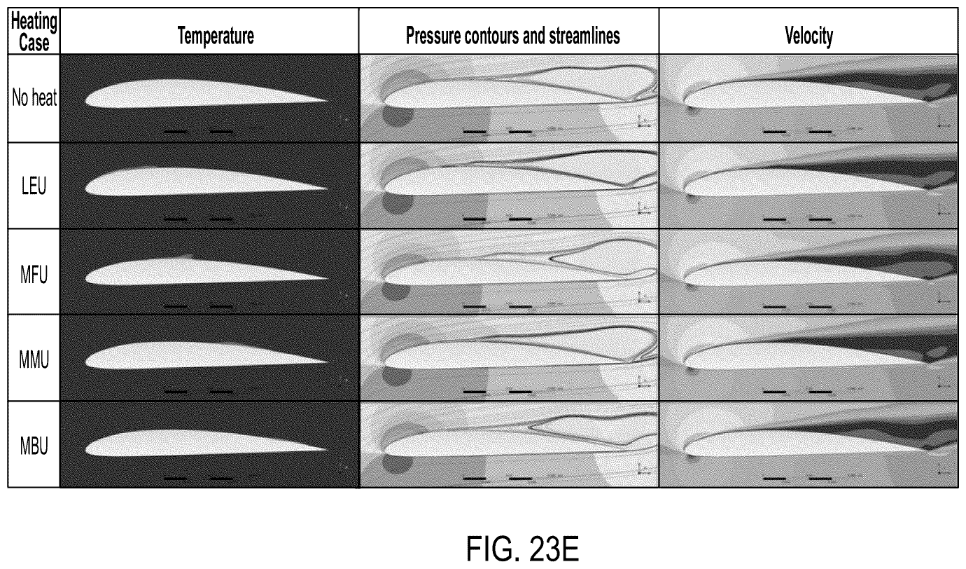

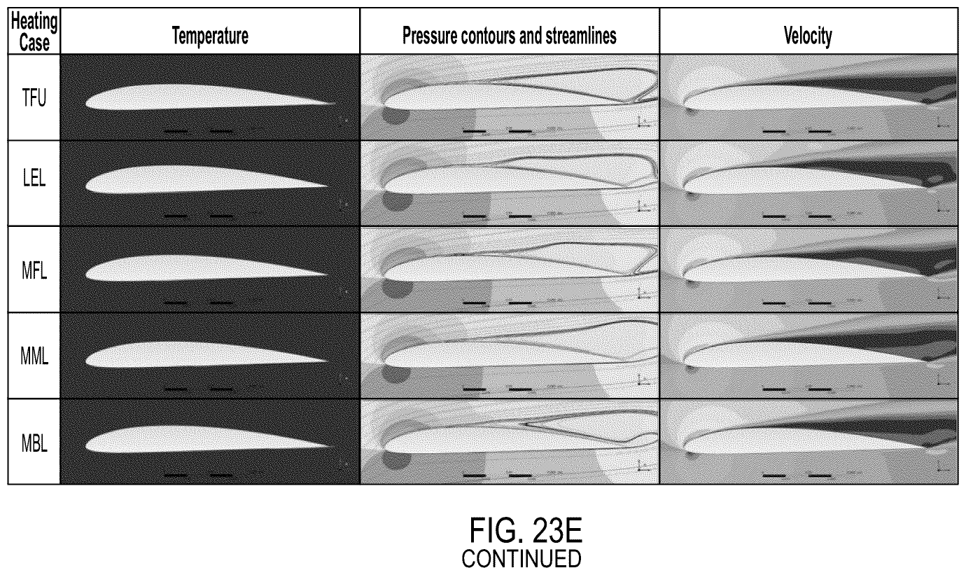

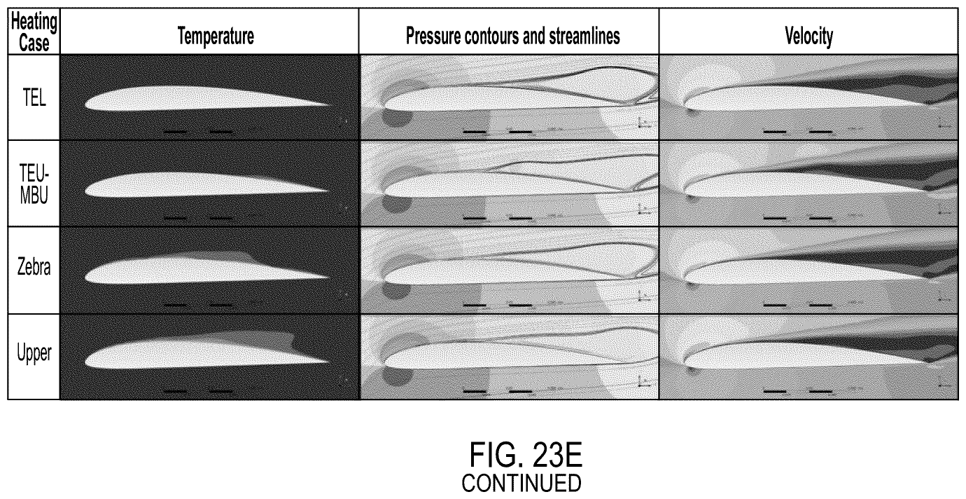

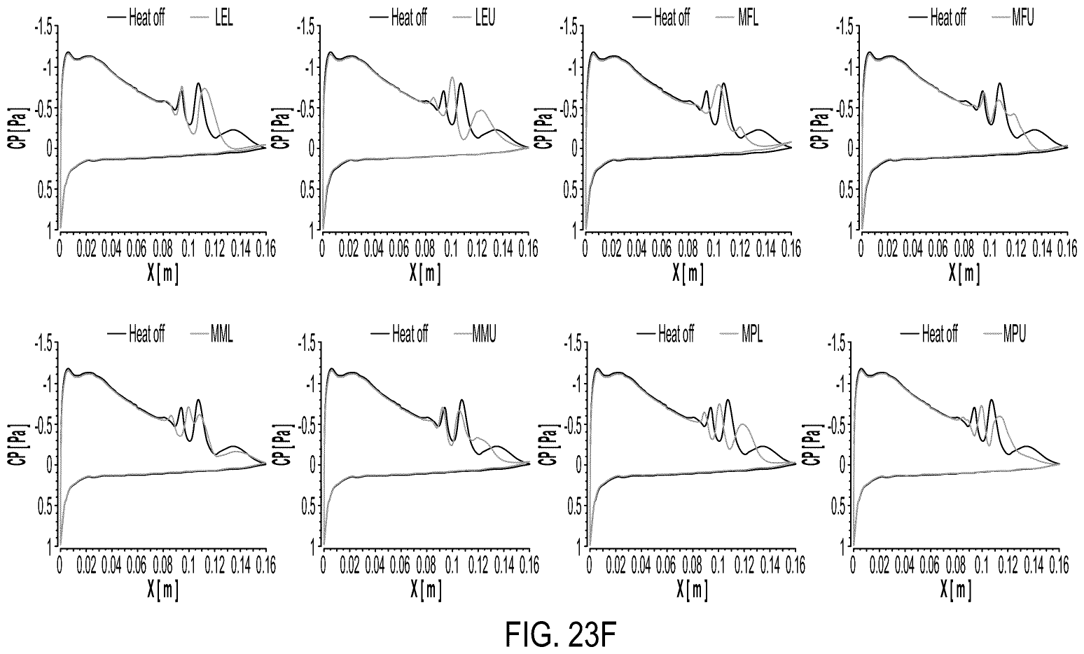

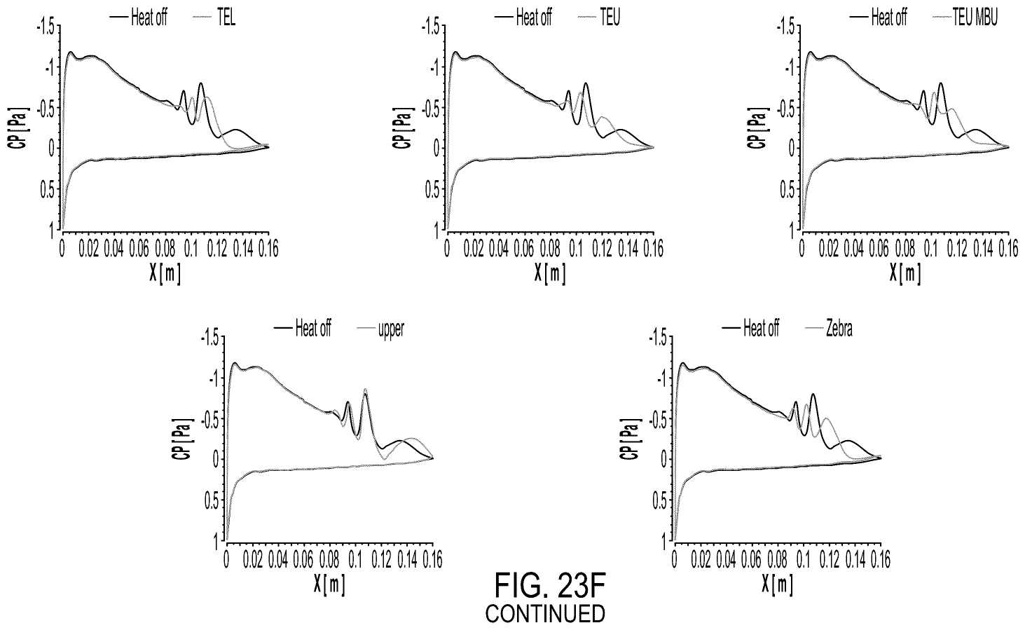

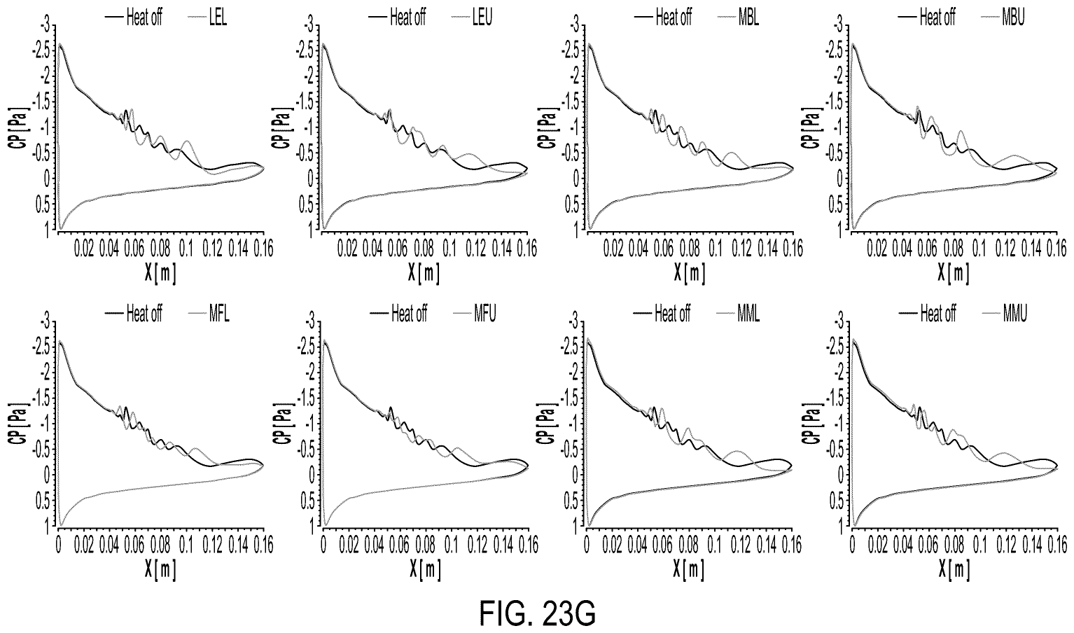

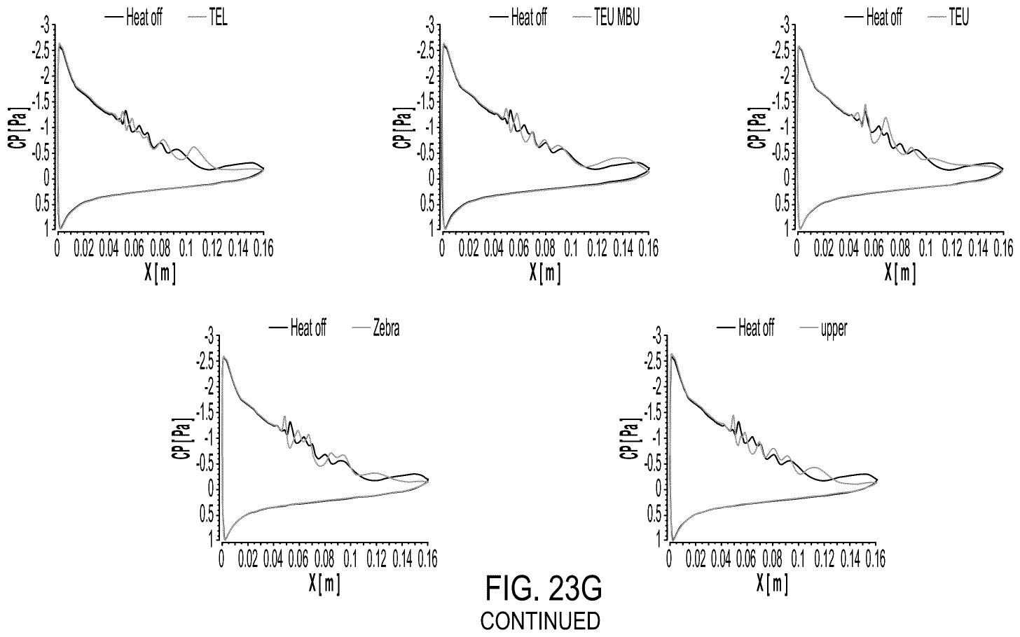

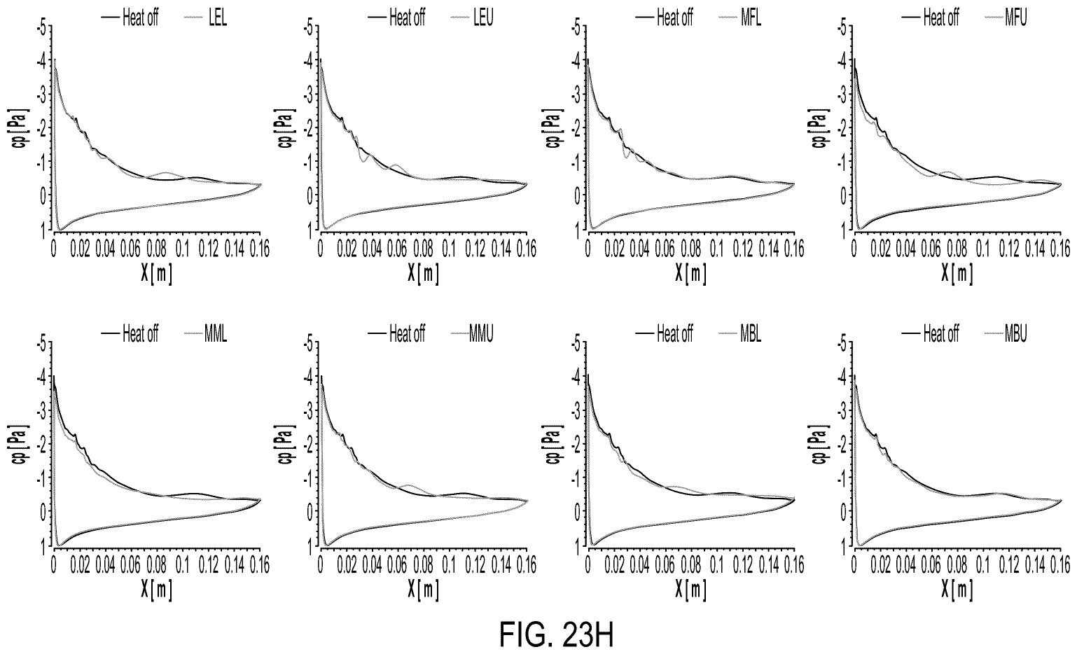

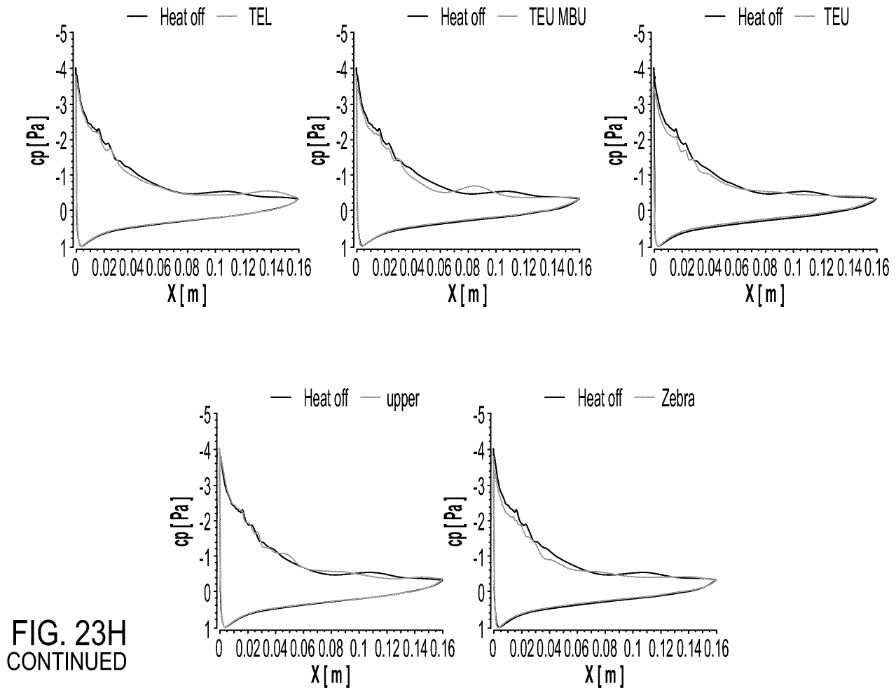

Computational fluid dynamics was used to visualize the flow field around the selected airfoil and provide the potential for further understanding of the heating effect on the aerodynamic performance. Steady flow around the heated airfoil configuration was predicted using CFD software, in which the Reynolds-averaged Nervier Stokes (“RANS”) equations were solved. The flow mesh domain with the airfoil in the center is presented in FIG. 23A and utilized the boundary conditions of the problem with a 9 m/s inlet velocity, zero gauge pressure outlet, and no-slip condition along the airfoil walls. To capture the boundary layers, a very fine mesh was constructed near the airfoil walls, as shown in FIG. 23B. This image also includes the heated surfaces for further clarification. The final mesh contained 212,973 elements. Different turbulence models were tested, and the four equation Transitional SST k-omega turbulence model was chosen to conduct these simulations.

Visual CFD results for the temperature, pressure, and velocity are shown in Tables 3 to 5 (see FIGS. 23C, 23D, and 23E). Three different angles of attack (0°, 5° and) 10° were used in the CFD simulation along with the previously defined heating patterns on the airfoil, similar to the experimental scenarios that were previously discussed. For the sake of convenience and visual ease, all resultant plots have been tabulated and are separated by low, medium, and high angles of attack in Tables 3 through 5. Table 3 houses the results for a low AOA (0°) setting and contains the temperature, velocity, and pressure contours with flow streamlines. The heating effect is very clear for the middle cases but is difficult to see in the leading and trailing edge due to the flow around the airfoil. This shows the change in the thermal boundary layer for each heating case and illustrates the small area of effect which is unique to each scenario. The velocity field for each simulation is shown to vary in the separation region as a result of the thermal boundary layer. A significant effect can be seen in the streamline plot, especially when looking at the upper heating cases. The heating affects both the shape and size of the separation region for each case which in turn will produce a corresponding effect on the lift and drag experienced by the wing. The wing had a separation region, including flow circulation covering the rear half chord. The height of this separation is not large; however, it has some noticeable ripples. As the wing's upper surface is heated, starting from the leading edge to the trailing edge, the ripples seem to be flattened and their height reduced. For the lower surface heating cases, the ripples in the separation are reduced, but the height of the separation region remains the same.

Moving on to the middle, and high angles of attack in Tables 4 and 5, respectively, the thermal effect can be seen in the separation region which is shown in the pressure contours and streamlines. The thermal effect of the heating remained significantly clear as the separation region's size was increased in each case when compared to the unheated simulation. This effect is evident when looking at both the pressure contour/streamline plot, as well as the flow velocity plot. At these higher angles, separation occurs more rapidly as expected. Due to this, the heating produces a smaller useful effect. As a result, higher angles of attack will have a reduced benefit from a temperature gradient across the chord of the wing; however, it will still produce an effect that may be considered significant for long-distance flights. Although this is a two-dimensional (“2D”) computation, a similar yet more complex solution will precipitate from a three-dimensional (“3D”) analysis as tip vortices are preferably considered.

To further illustrate the aerodynamic effects of heating, the pressure coefficient distribution was obtained, as shown in the tabulated figures in Tables 6, 7, and 8 (see FIGS. 23F, 23G, and 23H). Each case has been separately plotted against a non-heating case for ease of comparison, and the plots have been separated by the AOA and tabulated for convenience. The figures illustrate that the thermal effect occurs significantly in the separation region in the low and mid-AOA results. As noted previously, it can be seen that the heating affects the separation ripple shape, location, and size in both the velocity and pressure fields, which is further exemplified via the streamline contour plots. For high AOA, it appears to produce the same effect on the airfoil's upper surface; however, it is significantly reduced due to the separation point occurring much closer to the leading edge of the airfoil. It can be assumed that the thermal effect is still affecting the separation region, although its effect is greatly limited. When referencing the plots below, it can be seen in all cases that the curve of the heated airfoil closely follows the curve of the unheated case with the exception of the separation region. Within the separation region, it can be observed that the heated case diverges from the unheated and results in a change in aerodynamic forces. Every heating case had a unique effect on the separation of ripples' shape and size; this evidences that each color pattern produces a unique aerodynamics effect.

A supplementary series of simulations targeting higher speed flows has been methodically developed and integrated. Building upon the prior simulations and experimental endeavors, this advanced computational phase focuses on extending the understanding of the heating concept to regimes of higher velocities. While these computational findings are preliminary and pending experimental validation, they establish a foundational proof-of-concept for the potential effectiveness of our heating methodology under elevated speed conditions to show all ranges of flow can be affected. These simulations are not aimed to show optimal patterns or improvements, but purely to show there can be a measurable difference at these speeds. These new simulations were conducted at a Reynolds number of 10,426,523, with a flow temperature set at 283.24° C. Additionally, a new airfoil shape is used in place of high speed wind tunnel tests. This airfoil is provided by the NASA Common Research Model (CRM) and is publicly available for anyone to use. This airfoil was selected as the CRM provides both computational and experimental data that can be used for validation of a 3D CFD simulation. In these models, heat fluxes were variably applied to the upper rear half of the airfoil, ranging from 1 W/m² to 2000 W/m². This range was chosen to encompass the maximum anticipated radiation, approximated at 1500 W/m², thereby providing a spectrum for comparison. The results of these simulations, although in their nascent stage, offer a promising insight into the potential advantages our heating concept could yield in high-speed aerodynamic environments, as change in the aerodynamic properties can still be observed.

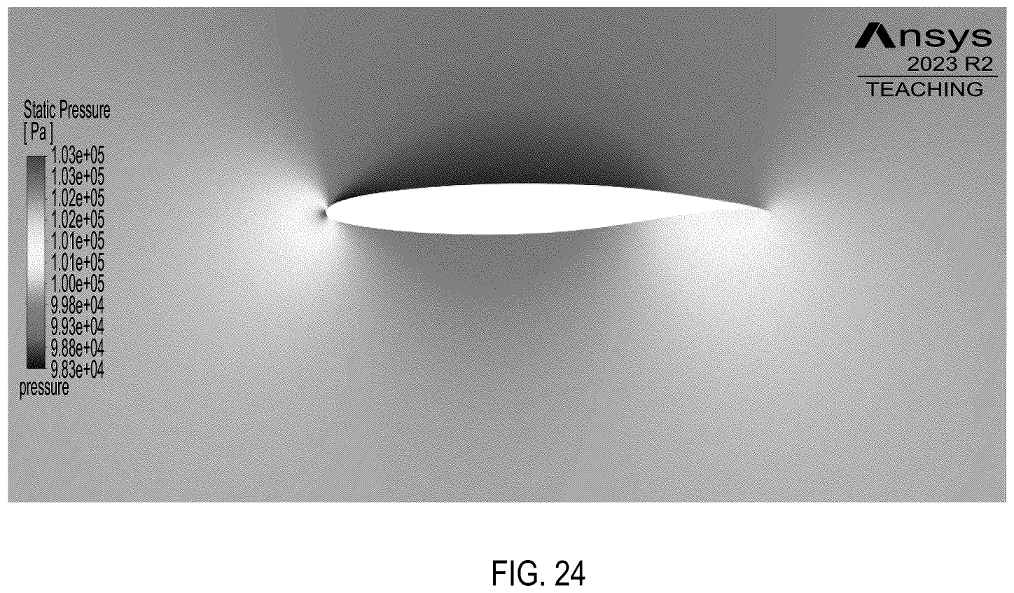

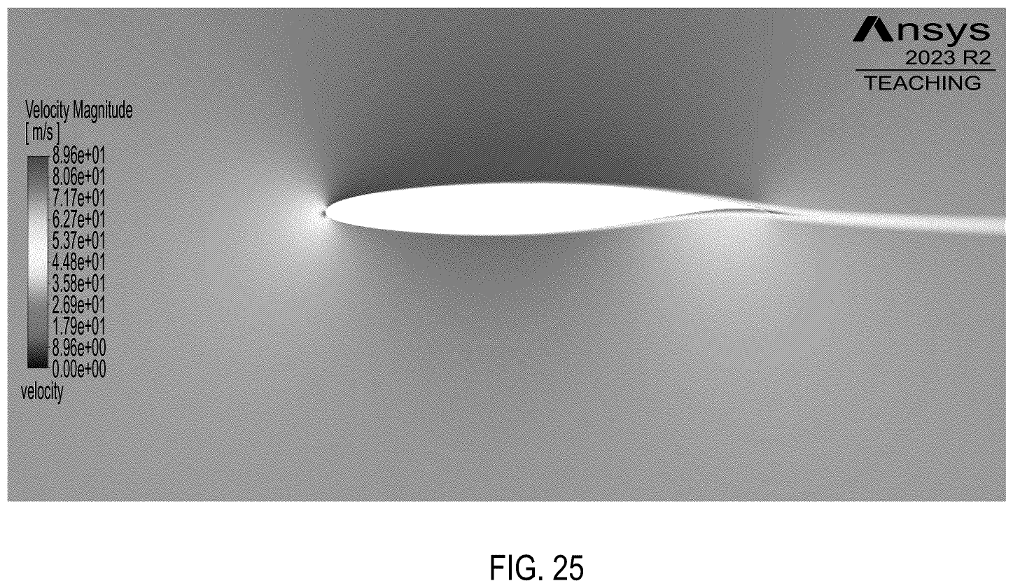

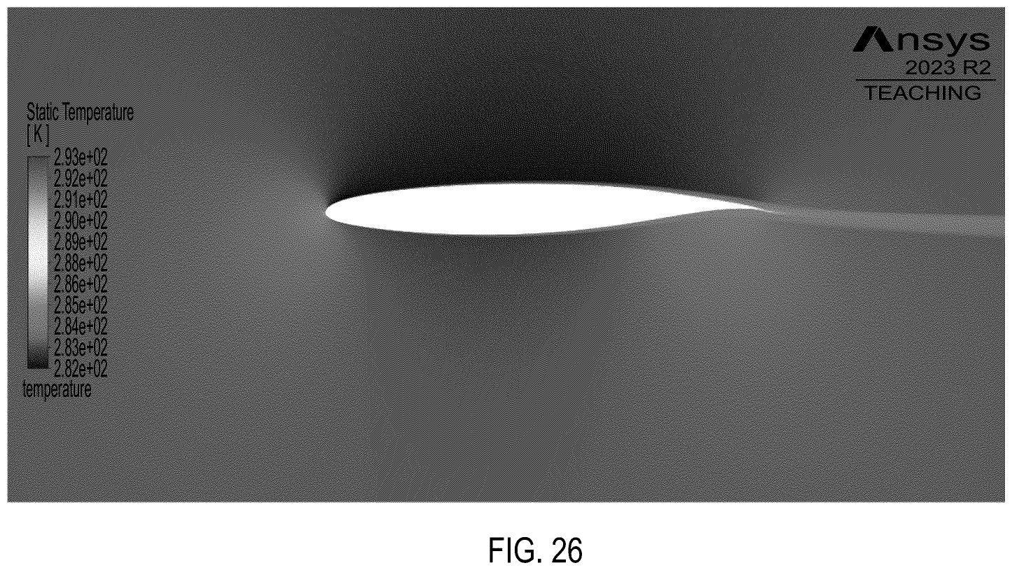

FIGS. 24-26 show examples of the temperature, pressure, and velocity distributions for this new CFD simulation, showing the changes induced by the heat-flux. There are no other changes beyond the heat-flux in these simulations. Simulation runs were performed at two AOAs, 0 and 4 degrees. The selected angles do not provide a detailed understanding of the changes in the heating effect; however, they do give a basic understanding of how the effect may influence the lift and drag as the AOA changes. The table below shows the results for 0 AOA cases with heating of 1, 1000, 1500, and 2000 W/m\hat{ }2,

TABLE 9
Heat-Fluxes at Different Combinations
of Angle-of-Attack and Heat

| Heating | 1 | 500 | 1000 | 1500 | 2000 |
|---|---|---|---|---|---|
| Cl/Cd | 43.094 | 43.05 | 43.008 | 42.964 | 42.921 |
| 0 AOA | | | | | |
| Cl/Cd | 65.403 | 67.235 | 67.162 | 69.096 | 67.092 |
| 4 AOA | | | | | |

Embodiments disclosed herein are configured to alter flight efficiency and/or performance by applying a color to a wing surface. In some examples, embodiments disclosed herein include a passive color pattern of a dark color, a light color and/or a combination of colors located on a wing surface that modifies the thermal and aerodynamic properties of the wing surface. In some examples, the passive color pattern is formed by applying a colorant, which can include, for example, a paint or a dye applied directly to the surface and/or a colorant that is applied to the material of the wing such that the color of the material from which the wing is formed is colored throughout the material and not just on the surface. Additionally or alternatively, embodiments disclosed herein include active heating elements that are configured to replicate and/or augment the thermal effects of a passive color pattern. Example active heating elements include, but are not limited to the application of heat films, resistive heating elements, heat pipes, and other similar technologies. In some examples, a passive color patter and active heating elements are combined to form a dual approach that further provides a comprehensive solution to modify the thermal and aerodynamic properties of the wing surface, thereby optimizing flight efficiency and performance for a wide range of aircraft types.

Materials have an intrinsic property related to their ability to reflect and absorb various amounts of radiation or light. As used herein, “reflectivity” refers to a fraction of irradiation reflected by a surface of material. As used herein, “absorptivity” refers to a fraction of irradiation absorbed by a surface of material. Each of reflectivity and absorptivity may be considered to be a ratio of the reflected light and the absorbed light, respectively, relative to the incident radiation on the surface of the material. Each color has a specific value for reflectivity and absorptivity, respectively, As used herein, a “reflectivity value” refers to a numeric representation of the reflectivity of a surface of material. Darker colors have a lesser reflectivity value, and light colors have a greater reflectivity value. For example, a perfectly black color may have a reflectivity of 0, and a perfectly white color may have a reflectivity of 1.

As used herein, a “dark color” refers to a color having a reflectivity value (referred to as a “dark reflectivity value”) that is less than a predefined lower reflectivity threshold and an absorptivity value (referred to as a “dark absorptivity value”) that is greater than a predefined upper absorptivity threshold. The term “dark color” may refer to a single dark color or a combination of a plurality of dark colors. As used herein, a “light color” refers to a color having a reflectivity value (referred to as a “light reflectivity value”) that is greater than a predefined upper reflectivity threshold and an absorptivity value (referred to as a “light absorptivity value”) that is less than a predefined lower absorptivity threshold. The term “light color” may refer to a single light color or a combination of a plurality of light colors. As used herein, a “dark color region” refers to a portion of an outer surface of a wing that is covered by a dark color. As used herein, a “light color region” refers to a portion of an outer surface of a wing that is covered by a light color. In some examples, a dark color region may be covered by a relatively small amount of light color (i.e. less than about 20% and more preferably less than about 10% of the total surface area of the described dark area) without destroying the benefits of applying a dark color to that area. For example, a dark color region may include pinstripe(s), text, and/or some other comparatively small area design element of a light color.

Another characteristic of material is emissivity. As used herein, “emissivity” refers to a measure of how much thermal radiation a body emits to its environment. As used herein, an “emissivity value” refers to a ratio of radiation emitted from a surface relative to a theoretical emission of an ideal black body. The emissivity value may be dependent on other material properties and may not necessarily distinguish between dark from light colors. However, when an object is in thermal equilibrium (e.g., a steady-state, no net heat transfer), the emissivity may be equivalent to the absorptivity.

As used herein a “root” of a wing refers to a region of the wing adjacent to a proximal end of the wing that is connected to and extends outwardly from a body of an aircraft. As used herein a “wingtip” of wing refers to a region of wing adjacent a distal tip of the wing. The wingtip may extend from the distal tip of the wing and inward no less than about 5%, and more preferably about 10%, most preferably between about 15% to about 20%, but no more than about 35% of the spanwise length of the wing.

As used herein, a “leading edge” refers to a region adjacent a front end of a wing that extends between a root and a tip of the wing. The leading edge may extend from the front end and inward no less than about 5%, more preferably about 15%, and most preferably about 20% to about 25%, but no more than about 50% of a chord length of the wing. As used herein, a “trailing edge” refers to a region adjacent a rear end of a wing that extends between a root and a tip of the wing. The trailing edge may extend from the rear end and inward no less than about 5%, more preferably about 15%, and most preferably about 20% to about 25%, but no more than about 50% of a chord length of the wing.

As used herein, a “centerline” of a wing refers to a line extending from a middle of a root chord to a middle of a tip chord. In some examples, the centerline may be colored symmetrically on each side and is preferably no less than about 2%, more preferably about 5%, and no more than about 20% of a wing chord. As used herein, an “upper portion” of a wing refers to a topside of the wing. As used herein, a “lower portion” of a wing refers to an underside of the wing. As used herein, an “entire portion” of the wing refers to a combination of both the upper portion and the lower portion. To define patterns, such as color patterns and/or thermal patterns, a combination of the above-provided terms, along with other descriptions, will be provided.

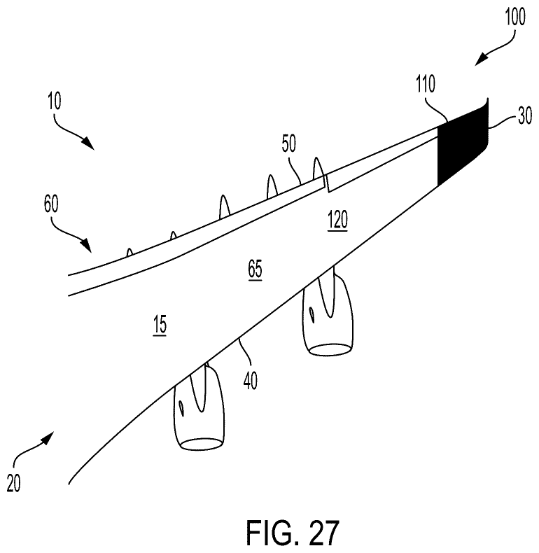

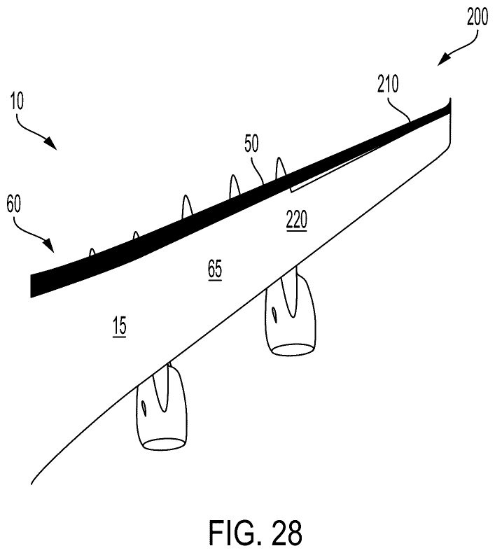

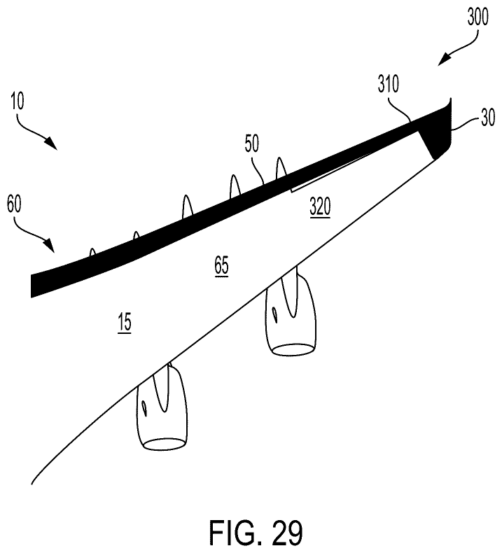

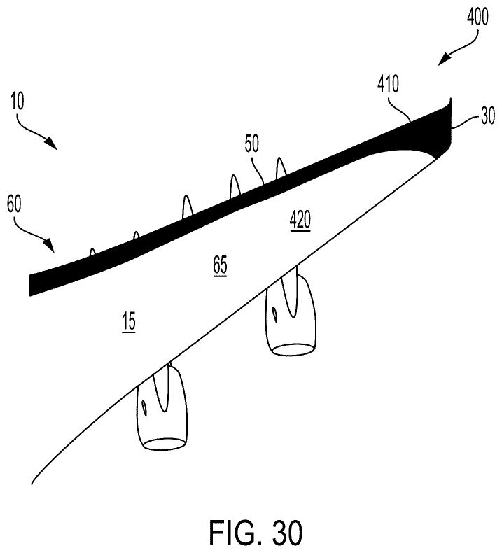

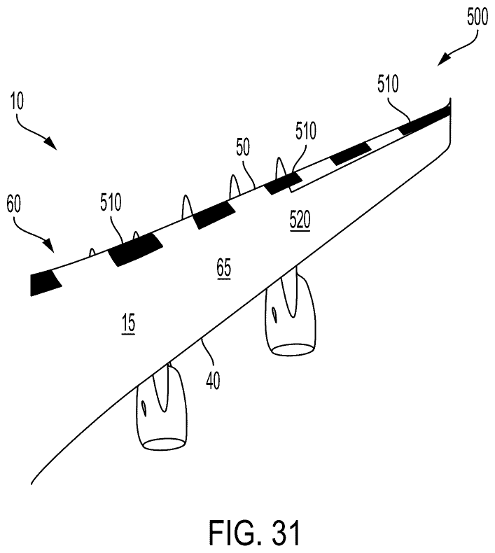

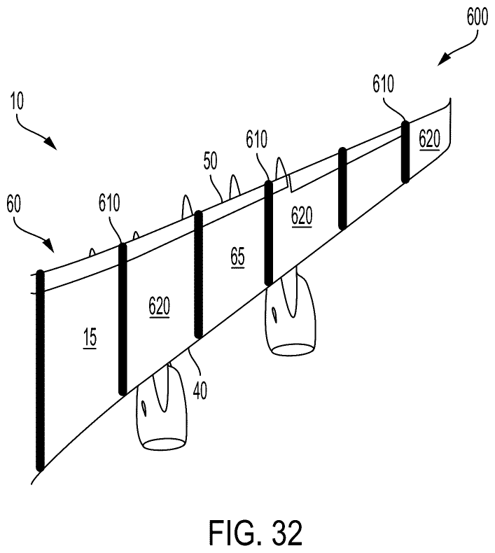

FIGS. 27-32 illustrate example color patterns disclosed herein that are configured to provide desirable aerodynamic characteristics of the wing. As illustrated therein, FIG. 27 depicts an example color pattern 100 of a wing 10 with dark color(s) applied to a wingtip 30. FIG. 28 depicts another example color pattern 200 of the wing 10 with dark color(s) applied along a trailing edge 50. FIG. 29 depicts another example color pattern 300 of the wing 10 with dark color(s) applied to the wingtip 30 and the trailing edge 50 and with the juncture between the wingtip 30 and the trailing edge 50 forming a sharp angle. FIG. 30 depicts another example color pattern 400 of the wing 10 with dark color(s) applied to the wingtip 30 and the trailing edge 50 and with the juncture between the wingtip 30 and the trailing edge 50 forming a curved shape. FIG. 31 depicts another example color pattern 500 of the wing 10 with dark color(s) applied to the trailing edge 50 in a striped pattern. FIG. 32 depicts another example color pattern 600 of the wing 10 with dark color(s) applied to the wing 10 in an alternating pattern of dark and light color(s). Further, in some examples, the dark pattern, regardless of where placed, can be a linear shape or a non-linear shape. In other examples, the dark color can be applied to the entirety or substantially all of the entirety of the upper surface of the wing.

As shown in FIGS. 27-32, the wing 10 includes a root 20, the wingtip 30, a leading edge 40, and the trailing edge 50. The root 20 is at a proximal end of the wing 10, and the wingtip 30 is at a distal end of the wing 10 opposite the root 20. The leading edge 40 is at a front end of the wing 10, and the trailing edge 50 is at a rear end of the wing 10. Each of the leading edge 40 and the trailing edge 50 extend between the root 20 and the wingtip 30.

Further, the wing 10 of the illustrated examples includes a topside 60 and an opposing underside. The wing 10 also includes an outer surface 15. The outer surface 15 includes an upper surface 65 on the topside 60 of the wing 10 and an opposing lower surface on the underside of the wing 10. In each of the illustrated examples, the wing 10 includes a color pattern (e.g., the color pattern 100 of FIG. 27, the color pattern 200 of FIG. 28, the color pattern 300 of FIG. 29, the color pattern 400 of FIG. 30, the color pattern 500 of FIG. 31, the color pattern 600 of FIG. 32) on the outer surface 15 to affect a vortex generation, a lift, a drag, a lift-to-drag ratio, a flight efficiency and/or other performance characteristic(s) of the wing 10.

The color pattern is on the upper surface 65 and/or lower surface of the wing 10. The color pattern may be on the upper surface 65 to increase the drag-to-lift ratio of the wing 10. The color pattern may be on the lower surface to generate a reduction in lift and/or increase in drag in instances in which such characteristics may be desired. In some examples, the color pattern extends along the upper surface 65 and does not extend along the lower surface. In other examples, the color pattern extends along both the upper surface 65 and the lower surface. In yet other examples, the color pattern extends along the lower surface but not the upper surface 65. For example, the color pattern may be applied to any one or more of the following:
1) an upper wingtip surface of the wingtip 30;
2) a lower wingtip surface of the wingtip 30;
3) an entirety of the wingtip 30 including the upper and lower wingtip surfaces;
4) a upper trailing edge surface of the trailing edge 50;
5) a lower trailing edge surface of the trailing edge 50;
6) an entirety of the trailing edge 50 including the upper and lower trailing edge surfaces;
7) an upper leading edge surface of the leading edge 40;
8) a lower leading edge surface of the leading edge 40; and/or
9) an entirety of the leading edge 40 including the upper and lower leading edge surfaces.

The upper wingtip surface is a portion of the wingtip 30 that extends along a portion of the upper surface 65 on the topside 60 of the wing 10. The lower wingtip surface is a portion of the wingtip 30 that extends along a portion of the lower surface on the underside of the wing 10. The upper trailing edge surface is a portion of the trailing edge 50 that extends along a portion of the upper surface 65 on the topside 60 of the wing 10. The lower trailing edge surface is a portion of the trailing edge 50 that extends along a portion of the lower surface on the underside of the wing 10. The upper leading edge surface is a portion of the leading edge 40 that extends along a portion of the upper surface 65 on the topside 60 of the wing 10. The lower leading edge surface is a portion of the leading edge 40 that extends along a portion of the lower surface on the underside of the wing 10.

In the illustrated examples of FIGS. 27-32, the color pattern includes a dark color region and a light color region. The dark color region and the light color region are arranged with respect to each other to manipulate a heat flux of the outer surface 15 that affects a pressure gradient and/or a velocity gradient surrounding the wing 10 to affect a vortex generation, a lift, a drag, and/or a lift-to-drag ratio of the wing 15. For example, the dark color region and the light color region are arranged with respect to each other to decrease the drag and/or increase the lift-to-drag ratio at a low angle-of-attack of the wing 10, which is associated with cruising conditions, to increase a flight range of a corresponding aircraft.

The dark color region is formed of a dark color having a dark absorptivity value, and the light color region is formed of a light color having a light absorptivity value. The dark absorptivity value is greater than the light absorptivity value. In some examples, the dark color of the dark color region and the light color of the light color region are selected based on the absorptivity levels of the colors and predefined absolute absorptivity thresholds. For example, the dark absorptivity value of the dark color in the dark color region is greater than a predefined upper absorptivity threshold (e.g., no less than 0.5 and preferably greater than 0.8), and the light absorptivity value of the light color in the light color region is less than a predefined lower absorptivity threshold (e.g., no greater than 0.5 and preferably less than 0.2). In other examples, the dark color of the dark color region and the light color of the light color region are selected based on the absorptivity levels of the colors and a predefined absorptivity differential threshold. For example, the dark absorptivity value of the dark color in the dark color region is greater than the light absorptivity value of the light color in the light color region by at least the predefined absorptivity differential threshold (e.g., no less than 0.2 and preferably greater than 0.5).

In FIG. 27, the color pattern 100 includes a dark color region 110 with the dark color and a light color region 120 with the light color. The dark color region 110 is disposed on the wingtip 30, and the light color region 120 is disposed on the remaining portion of the wing 10. For example, the dark color region 110 extends on the upper wingtip surface, the lower wingtip surface, and/or the entirety of the wingtip 30. The light color region 120 extends on remaining portion(s) of the upper surface 65 and/or the lower surface of the outer surface 15 of the wing 10.

In FIG. 28, the color pattern 200 includes a dark color region 210 with the dark color and a light color region 220 with the light color. The dark color region 210 is disposed on the trailing edge 50, and the light color region 220 is disposed on the remaining portion of the wing 10. For example, the dark color region 210 extends on the upper trailing edge surface, the lower trailing edge surface, and/or the entirety of the trailing edge 50. The light color region 220 extends on remaining portion(s) of the upper surface 65 and/or the lower surface of the outer surface 15 of the wing 10.

In FIG. 29, the color pattern 300 includes a dark color region 310 with the dark color and a light color region 320 with the light color. The dark color region 310 is disposed on the wingtip 30 and the trailing edge 50, and the light color region 320 is disposed on the remaining portion of the wing 10. The dark color region 310 forms a sharp angle between the wingtip 30 and the trailing edge 50. In some examples, the dark color region 310 extends on the upper wingtip surface and upper trailing edge surfaces, the lower wingtip and trailing edge surfaces, and/or the entirety of the wingtip 30 and the trailing edge 50. The light color region 320 extends on remaining portion(s) of the upper surface 65 and/or the lower surface of the outer surface 15 of the wing 10.

In FIG. 30, the color pattern 400 includes a dark color region 410 with the dark color and a light color region 420 with the light color. The dark color region 410 is disposed on the wingtip 30 and the trailing edge 50, and the light color region 420 is disposed on the remaining portion of the wing 10. The dark color region 410 forms a curved angle between the wingtip 30 and the trailing edge 50. In some examples, the dark color region 410 extends on the upper wingtip surface and upper trailing edge surfaces, the lower wingtip and trailing edge surfaces, and/or the entirety of the wingtip 30 and the trailing edge 50. The light color region 420 extends on remaining portion(s) of the upper surface 65 and/or the lower surface of the outer surface 15 of the wing 10.

In some examples, such as those shown in FIGS. 28-30, the application of dark colors on the upper trailing edge can include light colored spots in a manner similar to that of a monarch butterfly wing, which need not be perfectly round, with radii no smaller than about 1% of the wing chord, more preferably the radii are about 8% of the wing chord, and preferably no more than about 15% of the wing chord. That is, in such examples, the light color region includes spots located on and spaced apart along the trailing edge 50. In some such examples, the light colored spots are preferably spaced throughout the trailing edge 50, and most preferably no farther than about four times the spot radius from the trailing edge 50 of the wing 10 and no closer than about one spot radius from the trailing edge 50. The spacing between the spots is preferably no less than about 0.5% of the root to tip length, more preferably about 5% of the root to tip length, and preferably no greater than about 10% of the root to tip length.

In some examples, such as those shown in FIGS. 28-30, dark colors can be applied to the entirety of the trailing edge 50 with the addition of light colored spots, which need not be perfectly round, with radii that are preferably no smaller than about 5% of the wing chord, more preferably with radii that are about 8% of the wing chord, and preferably no more than about 15% of the wing chord. That is, in such examples, the light color region includes spots located on and spaced apart along the trailing edge 50. The spots are preferably spaced throughout the trailing edge 50, most preferably no farther than about 4 times the spot radius from the trailing edge 50 of the wing 10 and no closer than about one spot radius from the trailing edge 50. The spacing between spots is preferably no less than about 3% of the root to tip length, more preferably the spacing is about 5% of the root to tip length and is preferably not greater than about 10% of the root to tip length.

In FIG. 31, the color pattern 500 includes a dark color region 510 with the dark color and a light color region 520 with the light color. The dark color region 510 includes a plurality of stripes that extend along a portion of the trailing edge 50 in a direction toward the leading edge 40. The light color region 520 is disposed on the remaining portion of the wing 10. In some examples, the dark color region 510 extends on portions of the upper trailing edge surface, the trailing edge surface, and/or the entirety of the trailing edge 50. The light color region 520 extends on remaining portion(s) of the upper surface 65 and/or the lower surface of the outer surface 15 of the wing 10. That is, in some examples, the dark color(s) and the light color(s) are arranged on in an alternating pattern along the entirety of, or the substantially entirety of, the trailing edge 50, most preferably with a width no less than about 2% of the chord length, and more preferably a width of about 5% of the chord length, and preferably a width of not more than about 15% of the cord length.

In FIG. 32, the color pattern 600 includes a dark color region 610 with the dark color and a light color region 620 with the light color. The dark color region 610 includes a plurality of stripes that extend between the trailing edge 50 and the leading edge 40. The light color region 620 is disposed on the remaining portion of the wing 10. In some examples, the dark color region 610 extends on portions of the upper surface 65 and/or the lower surface of the outer surface 15 of the wing 10. The light color region 520 extends on remaining portion(s) of the upper surface 65 and/or the lower surface of the outer surface 15 of the wing 10. That is, in some examples, stripes (e.g., in a “zebra” pattern) span the chord of the wing 10, with each of the stripes of the dark color region 610 having a width of no less than about 2% of the root to tip length, more preferably about 5% of the root to tip length, and preferably a width of not more than about 10% of the root to tip length. In some such examples, the stripes of the dark color region 610 span the root to tip length of the wing 10 with a width of no less than about 2% of the chord length, more preferably about 5% of the chord length, and preferably not more than about 10% of the chord length.

In addition and/or as an alternative to a color pattern, the wing 10 includes one or more active heating elements to form a heat flux region on the wing 10 to manipulate a heat flux of the outer surface 15 of the wing 10. Example active heating elements include heat films, resistive heating elements, heat pipes, and other similar technologies. The active heating elements are configured to replicate and/or augment the thermal effects of a passive color pattern of the color pattern. For example, the active heating elements may be arranged to form a heat flux region that is shaped like the dark color region 110 of FIG. 27, the dark color region 210 of FIG. 28, the dark color region 310 of FIG. 29, the dark color region 410 of FIG. 30, the dark color region 510 of FIG. 31, and/or the dark color region 610 of FIG. 32.

The active heating elements are arranged to manipulate a heat flux of the outer surface 15 that affects a pressure gradient and/or a velocity gradient surrounding the wing 10 to affect a vortex generation, a lift, a drag, and/or a lift-to-drag ratio of the wing 15. For example, the active heating elements may be arranged with respect to each other to decrease the drag and/or increase the lift-to-drag ratio at a low angle-of-attack of the wing 10, which is associated with cruising conditions, to increase a flight range of a corresponding aircraft. The heat flux region may be on the upper surface 65 to increase the drag-to-lift ratio of the wing 10. The heat flux region may be on the lower surface to generate a reduction in lift and/or increase in drag in instances in which such characteristics may be desired. In some examples, the heat flux region extends along the upper surface 65 and does not extend along the lower surface. In other examples, the heat flux region extends along both the upper surface 65 and the lower surface. In yet other examples, the color pattern extends along the lower surface but not the upper surface 65.

The preceding examples can be repeated with similar success by substituting the generically or specifically described components and/or operating conditions of embodiments of the present invention for those used in the preceding examples.

Note that throughout this application, the terms “about”, “approximately”, and/or “substantially” means within twenty percent (20%) of the amount, value, or condition given.

Exemplary embodiments in accordance with the teachings herein are disclosed below.

Embodiment 1: A wing of an aircraft includes an outer surface and a color pattern on the outer surface. The color pattern includes a dark color region and a light color region. The dark color region is formed of a dark color having a dark absorptivity value. The light color region is formed of a light color having a light absorptivity value. The dark absorptivity value is greater than the light absorptivity value. The dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

Embodiment 2: The wing of embodiment 1, wherein the dark absorptivity value of the dark color is greater than a predefined upper absorptivity threshold and the light absorptivity value of the light color is less than a predefined lower absorptivity threshold.

Embodiment 3: The wing of embodiment 1 or 2, wherein the dark absorptivity value greater of the dark color is greater than the light absorptivity value of the light color by at least a predefined absorptivity differential threshold.

Embodiment 4: The wing of any of embodiments 1-3, further including at least one of a paint or dye applied to the outer surface to form the color pattern on the outer surface.

Embodiment 5: The wing of any of embodiments 1-4, further including one or more active heating elements arranged to further manipulate the heat flux of the outer surface.

Embodiment 6: The wing of embodiment 5, wherein the one or more active heating elements are configured to form a pattern that matches the dark color region of the color pattern.

Embodiment 7: The wing of embodiment 5 or 6, wherein the one or more active heating elements include at least one of a heat film, a resistive heating element, or a heat pipe.

Embodiment 8: The wing of any of embodiments 1-7, wherein the dark color region and the light color region are arranged with respect to each other to at least one of decrease the drag or increase the lift-to-drag ratio at a low angle-of-attack of the wing that is associated with cruising conditions to increase a flight range of the aircraft.

Embodiment 9: The wing of any of embodiments 1-8, further including a topside and an underside. The outer surface includes an upper surface on the topside and a lower surface on the underside.

Embodiment 10: The wing of embodiment 9, wherein the color pattern extends along the upper surface and does not extend along the lower surface.

Embodiment 11: The wing of embodiment 9, wherein the color pattern extends along the upper surface and the lower surface.

Embodiment 12: The wing of any of embodiments 9-11, further including a root at a proximal end, a wingtip at a distal end, a leading edge at a front and extending between the root and the wingtip, and a trailing edge at a rear and extending between the root and the wingtip.

Embodiment 13: The wing of embodiment 12, wherein the wingtip includes an upper wingtip surface extending along a portion of the topside and a lower wingtip surface extending along a portion of the underside.

Embodiment 14: The wing of embodiments 12 or 13, wherein the leading edge includes an upper leading edge surface extending along a portion of the topside and a lower leading edge surface extending along a portion of the underside.

Embodiment 15: The wing of any of embodiments 12-14, wherein the trailing edge includes an upper trailing edge surface extending along a portion of the topside and a lower trailing edge surface extending along a portion of the underside.

Embodiment 16: The wing of any of embodiments 12-15, wherein the dark color region extends along the wingtip and the light color region extends along a remaining portion of the outer surface.

Embodiment 17: The wing of any of embodiments 12-15, wherein the dark color region extends along the trailing edge and the light color region extends along a remaining portion of the outer surface.

Embodiment 18: The wing of any of embodiments 12-15, wherein the dark color region extends along the wingtip and the trailing edge and the light color region extends along a remaining portion of the outer surface.

Embodiment 19: The wing of embodiment 17 or 18, wherein the light color region further includes spots located on and spaced apart along the trailing edge.

Embodiment 20: The wing of any of embodiments 12-15, wherein the dark color region includes a plurality of stripes that extend along a portion of the trailing edge and in a direction toward the leading edge. The light color region extends along a remaining portion of the outer surface.

Embodiment 21: The wing of any of embodiments 12-15, wherein the dark color region includes a plurality of stripes that extend between the trailing edge and the leading edge. The light color region extends along a remaining portion of the outer surface.

Embodiment 22: The wing of any of embodiments 12-15, wherein the color pattern includes a zebra-pattern on the outer surface.

Embodiment 23: A wing of an aircraft includes an outer surface and one or more active heating elements arranged to form a heat flux region along the outer surface. The heat flux region is configured to manipulate a heat flux of the outer surface of the wing that affects at least one of a pressure gradient or a velocity gradient surrounding the wing to affect at least one of a vortex generation, a lift, a drag, or a lift-to-drag ratio of the wing.

Embodiment 24: The wing of embodiment 23, wherein the active heating element includes at least one of a heat film, a resistive heating element, or a heat pipe.

Embodiment 25: The wing of embodiment 23 or 24, further including a color pattern arranged to further manipulate the heat flux of the outer surface.

Embodiment 26: The wing of embodiment 25, wherein the color pattern includes a dark color region and a light color region. The dark color region is formed of a dark color having a dark absorptivity value. The light color region is formed of a light color having a light absorptivity value. The dark absorptivity value is greater than the light absorptivity value.

Embodiment 27: The wing of embodiment 26, wherein the dark color region of the color pattern forms a pattern that matches the heat flux region.

Embodiment 28: The wing of embodiment 26 or 27, wherein the dark absorptivity value of the dark color is greater than a predefined upper absorptivity threshold and the light absorptivity value of the light color is less than a predefined lower absorptivity threshold.

Embodiment 29: The wing of any of embodiments 26-28, wherein the dark absorptivity value greater of the dark color is greater than the light absorptivity value of the light color by at least a predefined absorptivity differential threshold.

Embodiment 30: The wing of any of embodiments 25-29, further including at least one of a paint or dye applied to the outer surface to form the color pattern on the outer surface.

Embodiment 31: The wing of any of embodiments 23-30, wherein the one or more active heating elements are arranged to at least one of decrease the drag or increase the lift-to-drag ratio at a low angle-of-attack of the wing that is associated with cruising conditions to increase a flight range of the aircraft.

Embodiment 32: The wing of any of embodiments 23-31, further including a topside and an underside. The outer surface includes an upper surface on the topside and a lower surface on the underside.

Embodiment 33: The wing of embodiment 32, wherein the heat flux region extends along the upper surface and does not extend along the lower surface.

Embodiment 34: The wing of embodiment 32, wherein the heat flux region extends along the upper surface and the lower surface.

Embodiment 35: The wing of any of embodiments 32-34, further including a root at a proximal end, a wingtip at a distal end, a leading edge at a front and extending between the root and the wingtip, and a trailing edge at a rear and extending between the root and the wingtip.

Embodiment 36: The wing of embodiment 35, wherein the wingtip includes an upper wingtip surface extending along a portion of the topside and a lower wingtip surface extending along a portion of the underside.

Embodiment 37: The wing of embodiments 35 or 36, wherein the leading edge includes an upper leading edge surface extending along a portion of the topside and a lower leading edge surface extending along a portion of the underside.

Embodiment 38: The wing of any of embodiments 35-37, wherein the trailing edge includes an upper trailing edge surface extending along a portion of the topside and a lower trailing edge surface extending along a portion of the underside.

Embodiment 39: The wing of any of embodiments 35-38, wherein the heat flux region extends along the wingtip and does not extend along a remaining portion of the outer surface.

Embodiment 40: The wing of any of embodiments 35-38, wherein the heat flux region extends along the trailing edge and does not extend along a remaining portion of the outer surface.

Embodiment 41: The wing of any of embodiments 35-38, wherein the heat flux region extends along the wingtip and the trailing edge and does not extend along a remaining portion of the outer surface.

Embodiment 42: The wing of embodiment 40 or 41, wherein heat flux region forms spots enclosed by the heat flux region along the trailing edge.

Embodiment 43: The wing of any of embodiments 35-38, wherein the heat flux region includes a plurality of stripes that extend along a portion of the trailing edge and in a direction toward the leading edge and does not extend along a remaining portion of the outer surface.

Embodiment 44: The wing of any of embodiments 35-38, wherein the heat flux region includes a plurality of stripes that extend between the trailing edge and the leading edge and does not extend along a remaining portion of the outer surface.

Embodiment 45: The wing of any of embodiments 35-38, wherein the heat flux region forms a zebra-pattern on the outer surface.

Embodiment 46: A method of forming a wing of an aircraft includes applying a color pattern having a dark color region and a light color region to an outer surface of the wing by applying a dark color having a dark absorptivity value to a dark color region and applying a light color having a light absorptivity value to the light color region. The dark absorptivity value is greater than the light absorptivity value. The dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

Embodiment 47: The method of embodiment 46, wherein the dark absorptivity value of the dark color is greater than a predefined upper absorptivity threshold and the light absorptivity value of the light color is less than a predefined lower absorptivity threshold.

Embodiment 48: The method of embodiment 46 or 47, wherein the dark absorptivity value greater of the dark color is greater than the light absorptivity value of the light color by at least a predefined absorptivity differential threshold.

Embodiment 49: The method of any of embodiments 46-48, wherein applying the color pattern includes applying at least one of a paint or dye to the outer surface of the wing.

Embodiment 50: The method of any of embodiments 46-49, further including installing one or more active heating elements on the wing to further manipulate the heat flux of the outer surface of the wing.

Embodiment 51: The method of embodiment 50, wherein the one or more active heating elements are installed to form a pattern that matches the dark color region of the color pattern.

Embodiment 52: The method of embodiment 50 or 51, wherein the one or more active heating elements include at least one of a heat film, a resistive heating element, or a heat pipe.

Embodiment 53: The method of any of embodiments 46-52, further including arranging wherein the dark color region and the light color region with respect to each other to at least one of decrease the drag or increase the lift-to-drag ratio at a low angle-of-attack of the wing that is associated with cruising conditions to increase a flight range of the aircraft.

Embodiment 54: The method of any of embodiments 46-53, wherein the color pattern is applied to an upper surface of the outer surface located on a topside of the wing and not to a lower surface of the outer surface located on an underside of the wing.

Embodiment 55: The method of any of embodiments 46-53, wherein the color pattern is applied to an upper surface of the outer surface located on a topside of the wing and to a lower surface of the outer surface located on an underside of the wing.

Embodiment 56: The method of any of embodiments 46-55, wherein the dark color region is applied to a wingtip of the wing and the light color region is applied a remaining portion of the outer surface.

Embodiment 57: The method of any of embodiments 46-55, wherein the dark color region is applied to a trailing edge of the wing and a light color region is applied to a remaining portion of the outer surface.

Embodiment 58: The method of any of embodiments 46-55, wherein the dark color region is applied to a wingtip and a trailing edge of the wing and a light color region is applied to a remaining portion of the outer surface.

Embodiment 59: The method of embodiment 57 or 58, wherein the light color region is applied to further include spots located on and spaced apart along the trailing edge.

Embodiment 60: The method of any of embodiments 46-55, wherein the dark color region is applied to includes a plurality of stripes that extend along a portion of a trailing edge of the wing and in a direction toward a leading edge of the wing. The light color region is applied to a remaining portion of the outer surface.

Embodiment 61: The method of any of embodiments 46-55, wherein the dark color region is applied to include a plurality of stripes that extend between a trailing edge and a leading edge of the wing. The light color region is applied to a remaining portion of the outer surface.

Embodiment 62: The method of any of embodiments 46-55, wherein the color pattern is applied to include a zebra-pattern on the outer surface of the wing.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A wing of an aircraft, comprising:
an outer surface; and
a color pattern on the outer surface,
wherein the color pattern includes a dark color region and a light color region,
wherein the dark color region is formed of a dark color having a dark absorptivity value,
wherein the light color region is formed of a light color having a light absorptivity value,
wherein the dark absorptivity value is greater than the light absorptivity value, and
wherein the dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

2. The wing of claim 1, wherein the dark absorptivity value of the dark color is greater than a predefined upper absorptivity threshold and the light absorptivity value of the light color is less than a predefined lower absorptivity threshold.

3. The wing of claim 1, wherein the dark absorptivity value greater of the dark color is greater than the light absorptivity value of the light color by at least a predefined absorptivity differential threshold.

4. The wing of claim 1, further comprising one or more active heating elements arranged to further manipulate the heat flux of the outer surface, wherein the one or more active heating elements include at least one of a heat film, a resistive heating element, or a heat pipe.

5. The wing of claim 4, wherein the one or more active heating elements are configured to form a pattern that matches the dark color region of the color pattern.

6. The wing of claim 1, wherein the dark color region and the light color region are arranged with respect to each other to at least one of decrease the drag or increase the lift-to-drag ratio at a low angle-of-attack of the wing that is associated with cruising conditions to increase a flight range of the aircraft.

7. The wing of claim 1, further comprising a topside and an underside, wherein the outer surface includes an upper surface on the topside and a lower surface on the underside.

8. The wing of claim 7, wherein the color pattern extends along the upper surface and does not extend along the lower surface.

9. The wing of claim 7, wherein the color pattern extends along the upper surface and the lower surface.

10. The wing of claim 7, further comprising:
a root at a proximal end;
a wingtip at a distal end;
a leading edge at a front and extending between the root and the wingtip; and
a trailing edge at a rear and extending between the root and the wingtip.

11. The wing of claim 10, wherein the dark color region extends along the wingtip and the light color region extends along a remaining portion of the outer surface.

12. The wing of claim 10, wherein the dark color region extends along the trailing edge and the light color region extends along a remaining portion of the outer surface.

13. The wing of claim 12, wherein the light color region further includes spots located on and spaced apart along the trailing edge.

14. The wing of claim 10, wherein the dark color region extends along the wingtip and the trailing edge and the light color region extends along a remaining portion of the outer surface.

15. The wing of claim 10, wherein the dark color region includes a plurality of stripes that extend along a portion of the trailing edge and in a direction toward the leading edge, and wherein the light color region extends along a remaining portion of the outer surface.

16. The wing of claim 10, wherein the dark color region includes a plurality of stripes that extend between the trailing edge and the leading edge, and wherein the light color region extends along a remaining portion of the outer surface.

17. The wing of claim 10, wherein the color pattern includes a zebra-pattern on the outer surface.

18. A method of forming a wing of an aircraft, the method comprising:
applying a color pattern having a dark color region and a light color region to an outer surface of the wing by:
applying a dark color having a dark absorptivity value to a dark color region; and
applying a light color having a light absorptivity value to the light color region,
wherein the dark absorptivity value is greater than the light absorptivity value, and
wherein the dark color region and the light color region are arranged with respect to each other to manipulate a heat flux of the outer surface of the wing that affects at least one of a pressure gradient or a velocity gradient surrounding the wing to affect at least one of a vortex generation, a lift, a drag, or a lift-to-drag ratio of the wing.

19. The method of claim 18, wherein applying the color pattern includes applying at least one of a paint or dye to the outer surface of the wing.

20. The method of claim 18, further comprising installing one or more active heating elements on the wing to further manipulate the heat flux of the outer surface of the wing.
